(19) United States
(12) Patent Application Publication
(10) Pub. No.: US 2025/0142185 A1
(43) Pub. Date: May 1, 2025

(54) Systems, Methods, and Media for Automated Creation of Analytics-Driven Audio-Visual Interactive Episodes

(71) Applicant: Storyline AI Inc., Malibu, CA (US)

(72) Inventors: Andrew R. Paley, Oak Park, IL (US); Andong Luis Li Zhao, Chicago, IL (US); David Navama, Malibu, CA (US)

(21) Appl. No.: 18/933,899

(22) Filed: Oct. 31, 2024

Related U.S. Application Data
(60) Provisional application No. 63/546,699, filed on Oct. 31, 2023.

(51) Int. Cl. H04N 21/8545; G06F 16/74; G06F 40/40; H04N 21/472

(52) U.S. Cl. CPC H04N 21/8545; G06F 16/743; G06F 40/40; H04N 21/472

(57) ABSTRACT

Systems, methods, and media for automated creation of analytics-driven audio-visual interactive episodes. The systems can include a specifically designed architecture that enables the systems to be configurable to any structured dataset and domain (including unstructured documents) while providing controls over analysis, content, language, flow, and visual presentation (theming) of the episodes. Additionally, the architecture can provide a deterministic implementation that allows for compliance with requirements of highly regulated industries.

### CROSS-REFERENCE TO RELATED APPLICATION

This application claims the benefit of and priority to U.S. Provisional Patent Application No. 63/546,699, filed on Oct. 31, 2023, the entire disclosure of which is incorporated herein by reference.

### TECHNICAL FIELD

The present disclosure pertains to improvements in the technical field of automated digital content creation.

### BRIEF DESCRIPTION OF THE DRAWINGS

FIG. 1 is a block diagram that illustrates components of an example episode generation system, in accordance with some aspects of the disclosure.

FIG. 2 is a block diagram that illustrates components of an example episode configuration subsystem that is associated with the episode generation system of FIG. 1, in accordance with some aspects of the disclosure.

FIG. 3 is a block diagram that illustrates components of an example analytic engine subsystem that is associated with the episode generation system of FIG. 1, in accordance with some aspects of the disclosure.

FIG. 4 is a block diagram that illustrates components of an example episode production subsystem that is associated with the episode generation system of FIG. 1, in accordance with some aspects of the disclosure.

FIG. 5A illustrates an example commodity performance scene 510 that can be included as part of a daily market brief episode that is associated with the episode generation system of FIG. 1, in accordance with some aspects of the disclosure.

FIG. 5B illustrates an example exchange rate scene that can be included as part of a daily market brief episode that is associated with the episode generation system of FIG. 1, in accordance with some aspects of the disclosure.

FIG. 5C illustrates an example industry group performance scene that can be included as part of a daily market brief episode that is associated with the episode generation system of FIG. 1, in accordance with some aspects of the disclosure.

FIG. 5D illustrates an example world market performance scene that can be included as part of a daily market brief episode that is associated with the episode generation system of FIG. 1, in accordance with some aspects of the disclosure.

FIG. 6A illustrates an example incurred cost scene that can be included as part of an insurance overview episode that is associated with the episode generation system of FIG. 1, in accordance with some aspects of the disclosure.

FIG. 6B illustrates an example open claims scene that can be included as part of an insurance overview episode that is associated with the episode generation system of FIG. 1, in accordance with some aspects of the disclosure.

FIG. 7A illustrates an example brand ranking scene that can be included as part of a retail overview episode that is associated with the episode generation system of FIG. 1, in accordance with some aspects of the disclosure.

FIG. 7B illustrates an example promotion optimization scene that can be included as part of a retail overview episode that is associated with the episode generation system of FIG. 1, in accordance with some aspects of the disclosure.

FIG. 7C illustrates an example growth trend scene that can be included as part of a retail overview episode that is associated with the episode generation system of FIG. 1, in accordance with some aspects of the disclosure.

FIG. 8A illustrates an example introduction scene that can be included as part of an earnings preview episode that is associated with the episode generation system of FIG. 1, in accordance with some aspects of the disclosure.

FIG. 8B illustrates an example earnings estimates scene that can be included as part of the earnings preview episode that is associated with the episode generation system of FIG. 1, in accordance with some aspects of the disclosure.

FIG. 8C illustrates an example performance comparison scene that can be included as part of an earnings preview episode that is associated with the episode generation system of FIG. 1, in accordance with some aspects of the disclosure.

FIG. 8D illustrates an example portfolio exposure scene that can be included as part of an earnings preview episode that is associated with the episode generation system of FIG. 1, in accordance with some aspects of the disclosure.

FIG. 8E illustrates an example recent headlines scene that can be included as part of an earnings preview episode that is associated with the episode generation system of FIG. 1, in accordance with some aspects of the disclosure.

FIG. 8F illustrates an example strategy introduction scene that can be included as part of an earnings preview episode that is associated with the episode generation system of FIG. 1, in accordance with some aspects of the disclosure.

FIG. 8G illustrates an example analyst consensus scene that can be included as part of an earnings preview episode that is associated with the episode generation system of FIG. 1, in accordance with some aspects of the disclosure.

FIG. 8H illustrates an example action scene that can be included as part of an earnings preview episode that is associated with the episode generation system of FIG. 1, in accordance with some aspects of the disclosure.

FIG. 8I illustrates an example trade types scene that can be included as part of an earnings preview episode that is associated with the episode generation system of FIG. 1, in accordance with some aspects of the disclosure.

FIG. 8J illustrates an example investor perspectives scene that can be included as part of an earnings preview episode that is associated with the episode generation system of FIG. 1, in accordance with some aspects of the disclosure.

FIG. 8K illustrates an example investor perspectives scene that can be included as part of an earnings preview episode that is associated with the episode generation system of FIG. 1, in accordance with some aspects of the disclosure.

FIG. 8L illustrates an example investor actions scene that can be included as part of an earnings preview episode that is associated with the episode generation system of FIG. 1, in accordance with some aspects of the disclosure.

FIG. 8M illustrates an example trade types scene that can be included as part of an earnings preview episode that is associated with the episode generation system of FIG. 1, in accordance with some aspects of the disclosure.

FIG. 8N illustrates an example support scene that can be included as part of an earnings preview episode that is associated with the episode generation system of FIG. 1, in accordance with some aspects of the disclosure.

FIG. 9 is a flow diagram that illustrates an example episode generation process that can be performed by the episode generation system of FIG. 1, in accordance with some aspects of the disclosure.

FIG. 10 is a block diagram showing components of an example distributed computing environment, in accordance with some aspects of the disclosure.

FIG. 11 is a block diagram showing components of an example computing system, in accordance with some aspects of the disclosure.

### DETAILED DESCRIPTION

The following is a detailed description of various aspects of the disclosure. The scope of the disclosure can encompass numerous alternatives, modifications, and equivalents, and is limited only by the claims. While numerous specific details are set forth in the following description, the disclosure may be practiced according to the claims without some or all of these specific details. Various aspects will be detailed with reference to the accompanying drawings. However, it should be noted that references made to the examples are for illustrative purposes, and are not intended to limit the scope of the claims.

The space of generative media, including, for example, prose, images, music, and video, has a relatively long history, but has seen an explosion of activity in the past 3 to 5 years. To date, two different fundamental approaches have dominated the space: 1) the use of knowledge representation and various forms of inference engines and analytic packages, and 2) deep learning-based models, with the most recent breakthroughs coming from the transformer architecture.

In the first approach, the academic literature and other prior art demonstrates a collective exploration of the use of ontological modeling and various forms of data analysis and analytic-package patterns in pursuit of language and document generation systems or visualization annotation systems. While these techniques have some benefits with respect to aspects of traceability and composability as well as elements of extensibility through configuration, the focus on the specific task of data-driven language and document generation confines them to a singular modality limited in scope, utility, and consumability, precluding, among other things: multimodal delivery; audio-visual event sync; dynamic interactivity; multi-sensory personalization such as through use of music, narration, imagery, and animation; dynamic collaboration tooling; consumer-side analytics; and content optimization through feedback loops. Further, prior academic work has touched on structured question-answering systems based on ontological modeling and compositional analytics, but in forms that leave the exploration up to the human in the loop, limiting such systems utility to users already domain-aware and capable of driving data explorations, and without focus on the distribution of pre-tailored information to wider circles of consumers or on broader narrative arcs that take into account dynamics across discrete information elements, contexts or timeframes. Further, these systems have typically relied on text and static visualizations to convey answers, again severely limiting them in a variety of ways similar to those noted above.

Moving into the space of deep-learning based generative approaches, large language models and other forms of transformer models aimed at generative tasks such as prompt-driven image generation or text-to-speech have proven incredibly powerful and capable in recent history. That said, when it comes not to fluency or coherence, but instead to facts and truthful information, much has been discussed of the “black box” nature of such models as well as their penchant for “hallucination” or the invention of untrue facts in pursuit of coherent sentence or other structures. Given that, these factors render their behaviors largely untraceable, unauditable, nondeterministic and, ultimately, unreliable in contexts where accuracy, consistency and truth matters, especially at scale. This in turn limits their utility to domains in which a) the system can rely on a human-expert-in-the-loop to tailor, correct and guide the model output, making decisions about veracity on the fly, b) quality assurance checks can be automated against the model output, and/or c) such hallucinations and untraceable outputs are not a problem, such as with game worlds, fictional stories, or collaborative writing.

Much research and product development has gone into the use of well-defined context windows to serve as fodder for information-driven interactions with such models, but they still are shown to suffer from hallucinations of various sorts, even when constrained. Further, little focus has been placed on how to generate such context windows dynamically, on demand, cross-domain and at scale. Additionally, and despite much research and safeguarding in both academic and commercial contexts, various deep learning models have been shown to produce harmful content in unexpected or unforeseen ways, ranging from expressions of bias, including racial, gender, or religious bias, to abusive, violent or illegal suggestions. Also, whatever safeguards exist have repeatedly been shown to be bypassable through “adversarial attacks” via approaches as simple as question rephrasing or addition of specific introductory or supplementary text.

Finally, the immediate output of these models tends to be focused on a single modality-text, images, limited-length videos—and is constrained in narrative scope. The greatest successes to date in long form generation have been in the space of prose, but the longer the body of text, the more risk of hallucinations which largely relegates lengthy prose to the space of fiction or as input to a verification/editing process, and steering such long form generation is a nontrivial task. Meanwhile, generative video is resource intensive and, without significant human intervention or editing on each output, has been to date limited in utility or scope to exploratory, experimental and artistic work with no significant pursuit of truthful information conveyance.

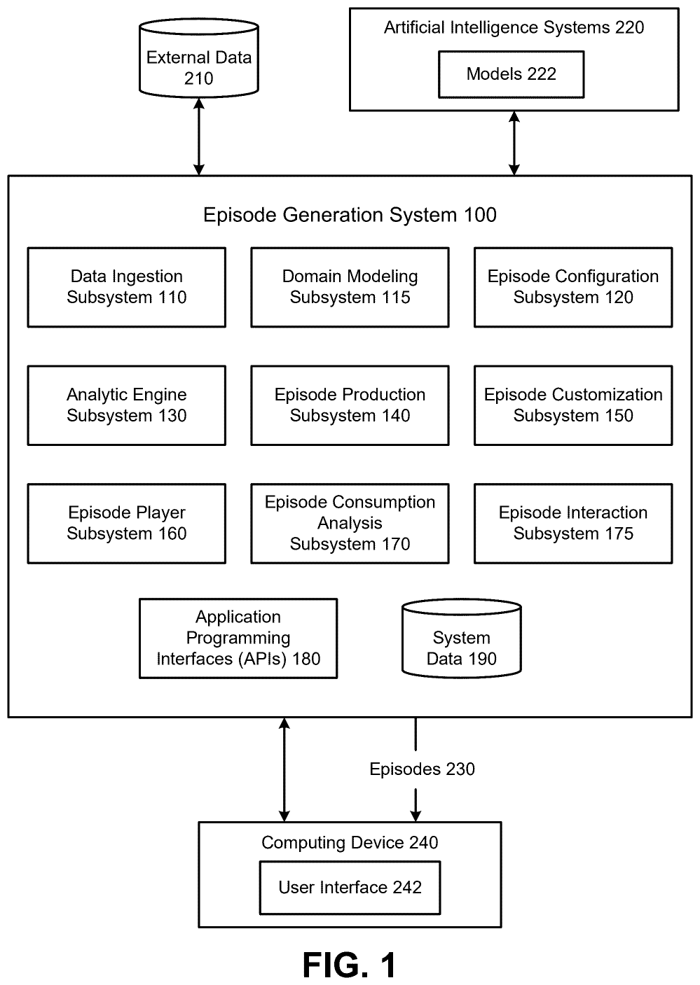

Referring to FIG. 1, a block diagram illustrating components of an example episode generation system 100 is shown, in accordance with some aspects of the disclosure. The episode generation system 100 can generally be configured to ingest external data 210, generate an episodes 230 based on the external data 210, and cause the episodes 230 to be presented on a computing device 240 via a user interface 242. The episodes 230 can be a personalized, AI-powered video that can be used for a variety of purposes, such as analyzing investments, educating clients, converting prospects, engaging customers, upselling products, retaining business, and/or selling services, for example. The episode generation system 100 can be specifically designed using a modular framework with swappable components that allow the episode generation system 100 to be flexible and adaptable for different applications. For example, the modular design of the episode generation system 100 can allow the episode generation system 100 to be adapted for use in finance, insurance, and retail applications, among many others. The modular design of the episode generation system 100 can allow various components of the episode generation system 100 to be adapted for use with new technologies as they emerge without altering other components. The episode generation system 100 can be implemented using various types of hardware, software, firmware, and/or networking implementations, as detailed below with respect to the distributed computing environment 1000 and/or the computing system 1100.

As shown in FIG. 1, the episode generation system 100 can include various subsystems, including, for example, a data ingestion subsystem 110, a domain modeling subsystem 115, an episode configuration subsystem 120, an analytic engine subsystem 130, an episode production subsystem 140, an episode customization subsystem 150, an episode player subsystem 160, an episode analysis subsystem 170, an episode interaction subsystem 175, and a media service subsystem 180. The data ingestion subsystem 110, the domain modeling subsystem 115, the episode configuration subsystem 120, the analytic engine subsystem 130, the episode production subsystem 140, the episode customization subsystem 150, the episode player subsystem 160, the episode analysis subsystem 170, the episode interaction subsystem 175, and the media service subsystem 180 can be implemented in various suitable manners, and can be combined in various suitable manners. Further, any of the data ingestion subsystem 110, the domain modeling subsystem 115, the episode configuration subsystem 120, the analytic engine subsystem 130, the episode production subsystem 140, the episode customization subsystem 150, the episode player subsystem 160, the episode analysis subsystem 170, the episode interaction subsystem 175, and the media service subsystem 180 can be implemented using multiple separate subsystems.

The episode generation system 100 is also shown to include application programming interfaces (APIs) 180 and system data 190 in FIG. 1. The APIs 180 can be used to facilitate provision of various services to users that desire access to any of the components of the episode generation system 100. The APIs 180 can include any suitable types of application programming interfaces. For example, the APIs 180 can include one or more representational state transfer application programming interfaces (REST APIs) and/or other suitable types of application programming interfaces. The system data 190 can include any data associated with the episode generation system 100. For example, the system data 190 can include any of the data and the libraries associated with the data ingestion subsystem 110, the domain modeling subsystem 115, the episode configuration subsystem 120, the analytic engine subsystem 130, the episode production subsystem 140, the episode customization subsystem 150, the episode player subsystem 160, the episode analysis subsystem 170, and the episode interaction subsystem 175 as detailed below.

As shown in FIG. 1, the episode generation system 100 can interface with various types of external systems. For example, the episode generation system 100 can interface with various types of external databases to retrieve the external data 210. The episode generation system 100 can also interface with various types of artificial intelligence systems 220 and associated models 222 that are maintained by the artificial intelligence system 220 for various purposes. The episode generation system 100 can interface with the external databases to retrieve the external data 210 via various suitable application programming interfaces provided by the external data sources, for example. Similarly, the episode generation system 100 can interface with the artificial intelligence systems 220 and the models 222 via various suitable application programming interfaces provided by the artificial intelligence systems 220, for example. The models 222 can include large language models, voiceover models, for example, among other suitable types of models (e.g., text-to-video, etc.). However, it should be noted that the architecture of the episode generation system 100 allows the episode generation system 100 to perform any of the functionality that is described as being performed by interfacing with the artificial intelligence systems 220 and the models 222 by instead using one or more models that are native to the episode generation system 100 (e.g., specifically designed models for the episode generation system 100, open-source models deployed within the episode generation system 100, etc.).

As shown in FIG. 1, the episode generation system 100 can also interface with the computing device 240 to cause the episodes 230 to be presented on the computing device 240 via the user interface 242. The episode generation system 100 can also interface with the computing device 240 to receive user inputs from the computing device 240 (e.g., as entered via the user interface 242) and to provide additional content to the computing device 240 (e.g., different types of output files beyond the episodes 230). The computing device 240 can be any suitable type of computing device, such as a smartphone, a tablet, a laptop, a desktop computer, a wearable device, a virtual reality (VR) device, or an electric vehicle, for example. The user interface 242 can also be any suitable type of user interface, including a web interface (e.g., presented via a web browser), an application interface (e.g., a mobile application, a desktop application, etc.), a virtual reality interface, a podcast interface, an electric vehicle interface, etc.

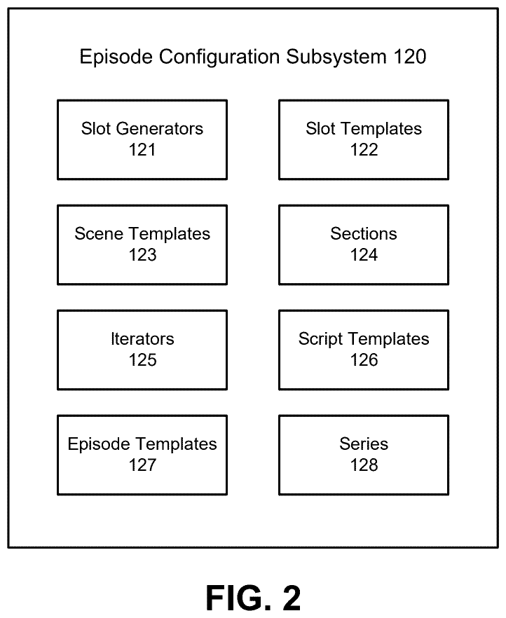

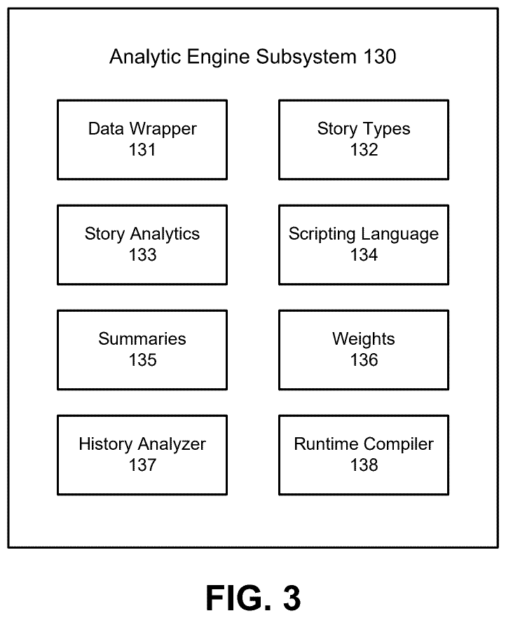

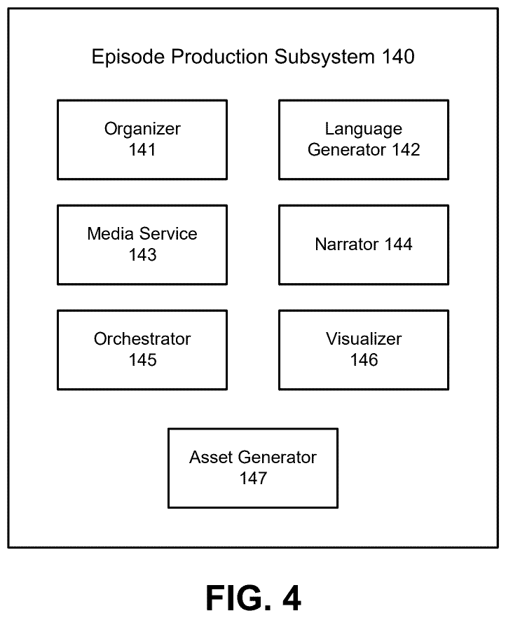

Referring to FIG. 2, a block diagram illustrating the episode configuration subsystem 120 of the episode generation system 100 is shown, in accordance with some aspects of the disclosure. As shown, the episode configuration subsystem 120 can include slot generators 121, slot templates 122, scene templates 123, sections 124, iterators 125, script templates 126, episode templates 127, and series 128. Referring to FIG. 3, a block diagram illustrating the analytic engine subsystem 130 of the episode generation system 100 is shown, in accordance with some aspects of the disclosure. As shown, the analytic engine subsystem 130 can include a data wrapper 131, story types 132, story analytics 133, a scripting language 134, summaries 135, weights 136, a history analyzer 137, and a runtime compiler 138. Referring to FIG. 4, a block diagram illustrating the episode production subsystem 140 of the episode generation system 100 is shown, in accordance with some aspects of the disclosure. As shown, the episode production subsystem 140 can include an organizer 141, a language generator 142, an orchestrator 143, a narrator 144, a visualizer 145, an embedder 146, a synchronizer 147, and an asset generator 148.

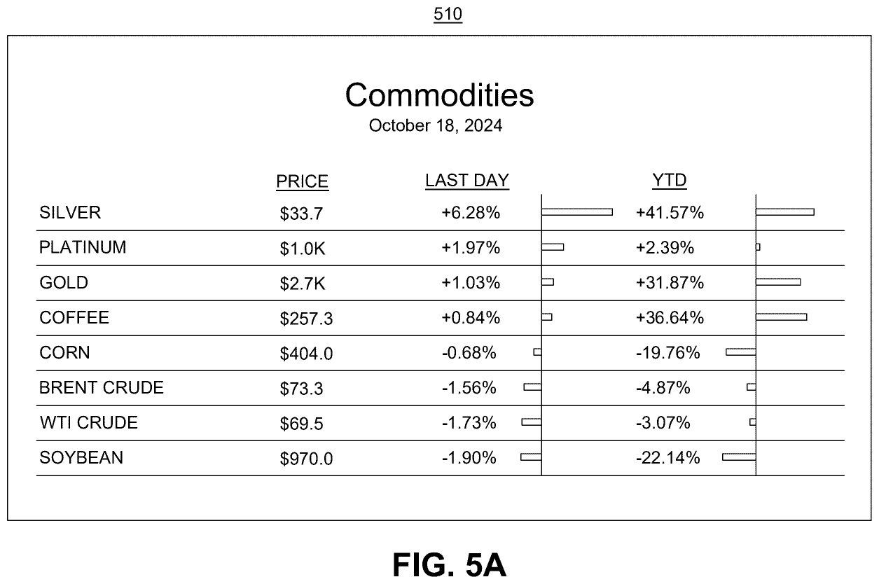

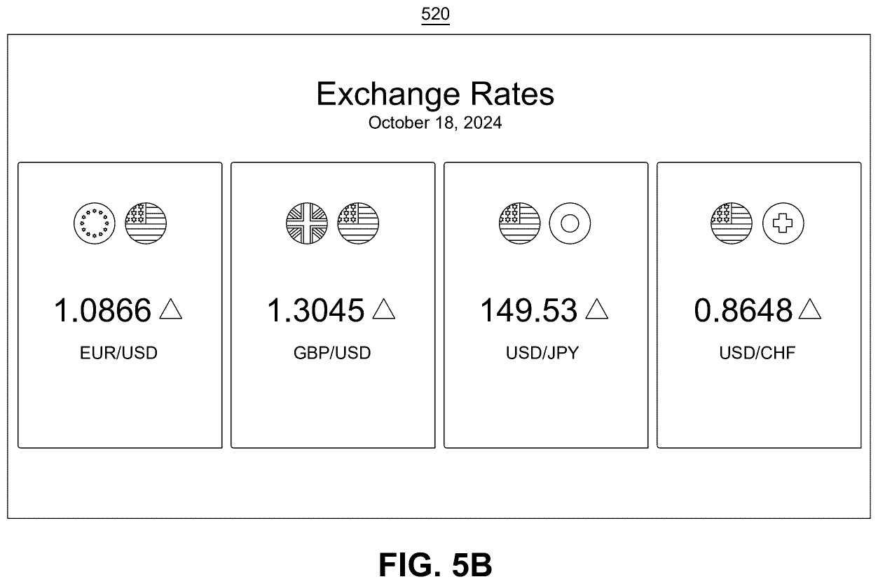

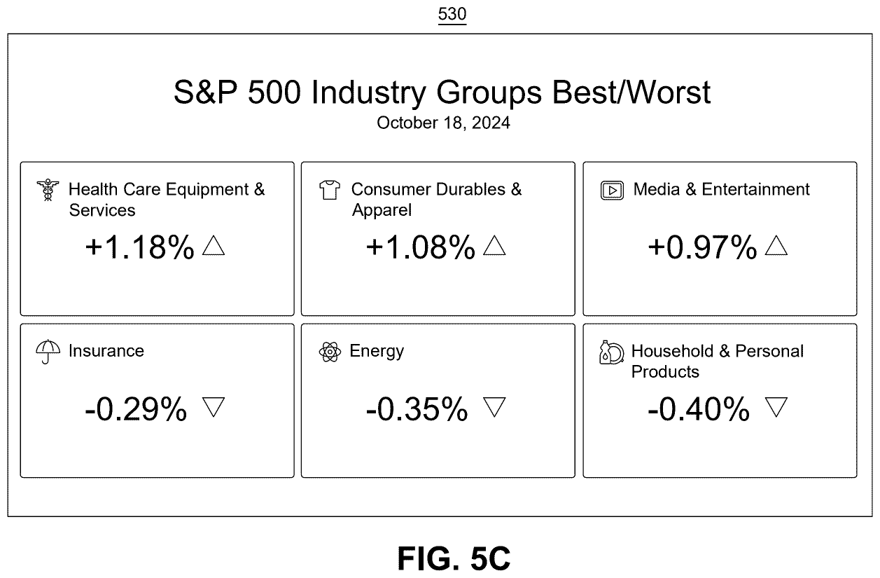

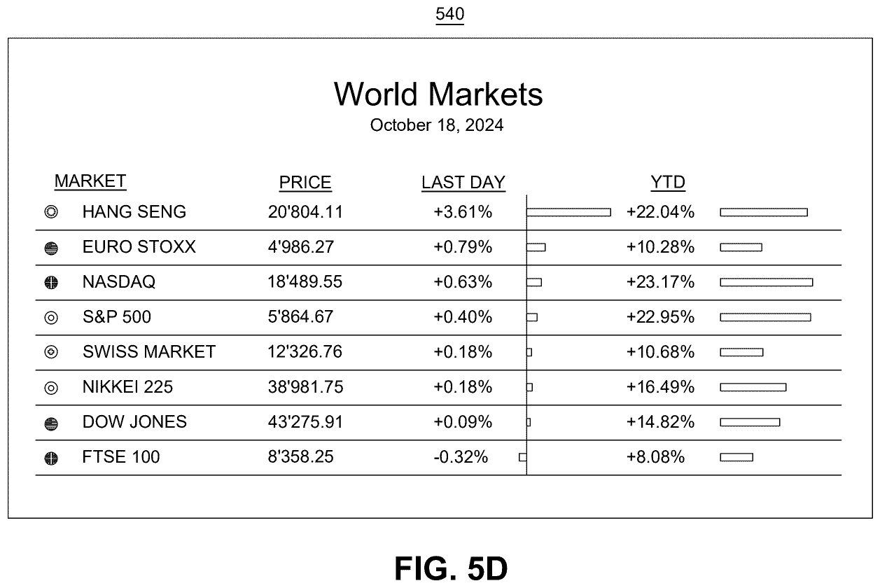

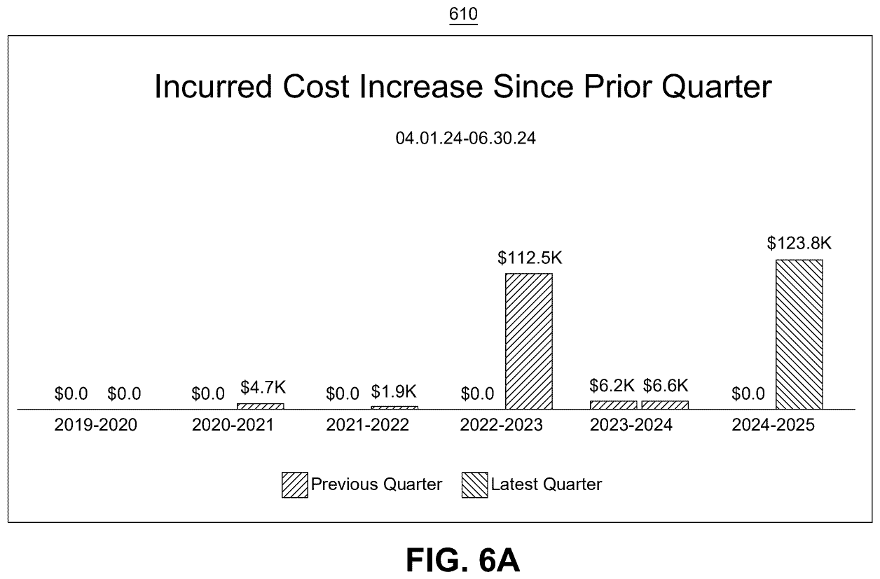

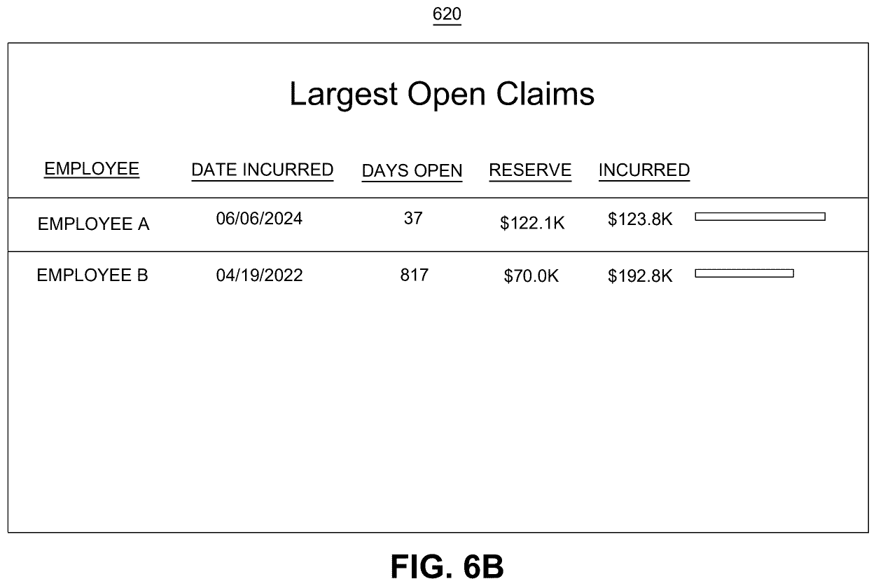

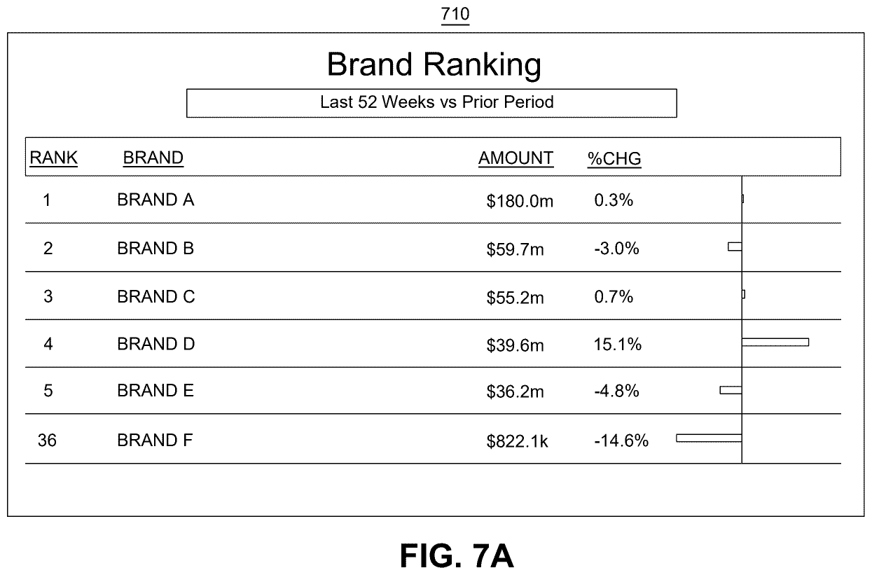

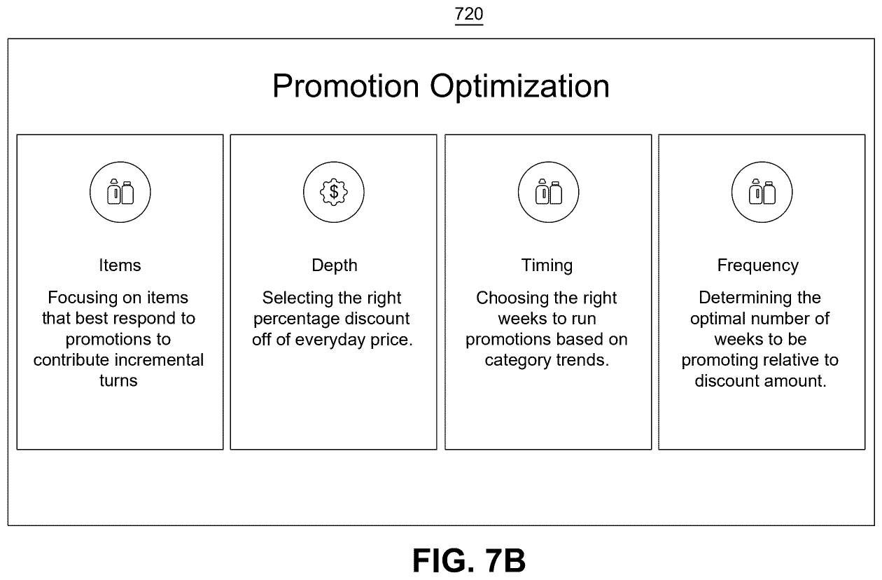

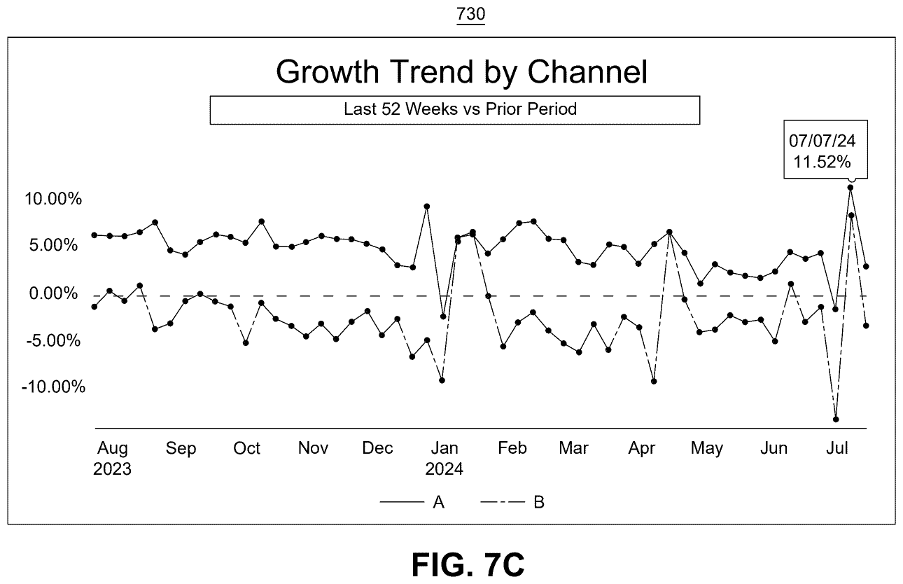

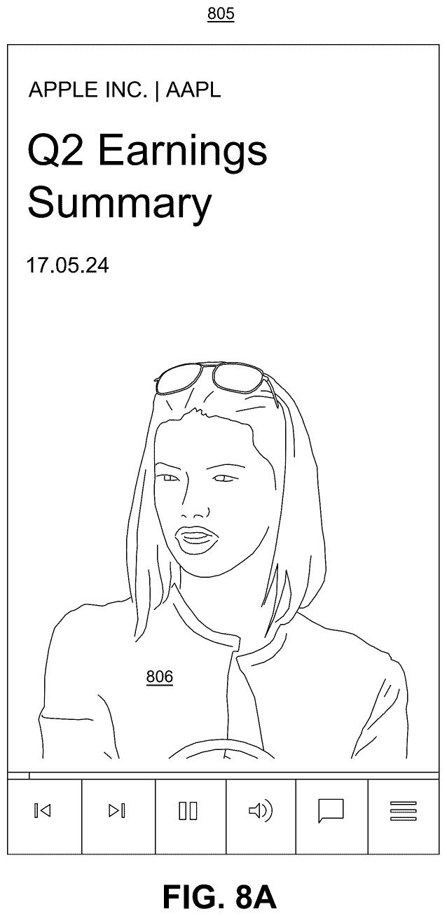

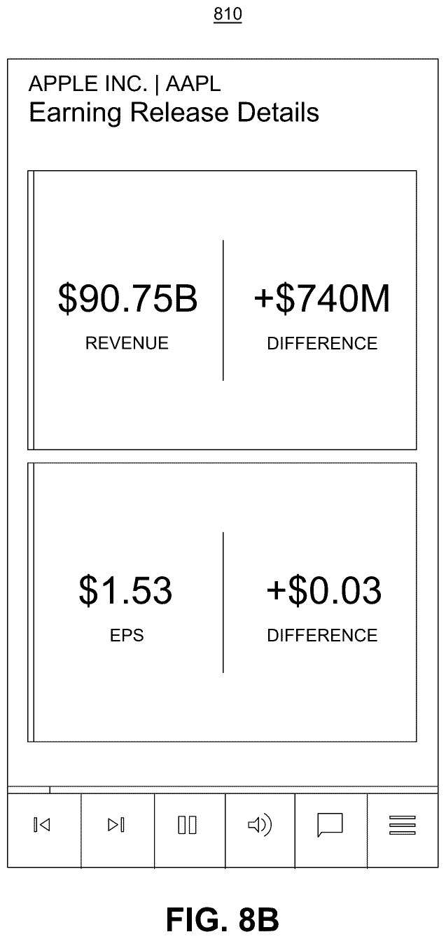

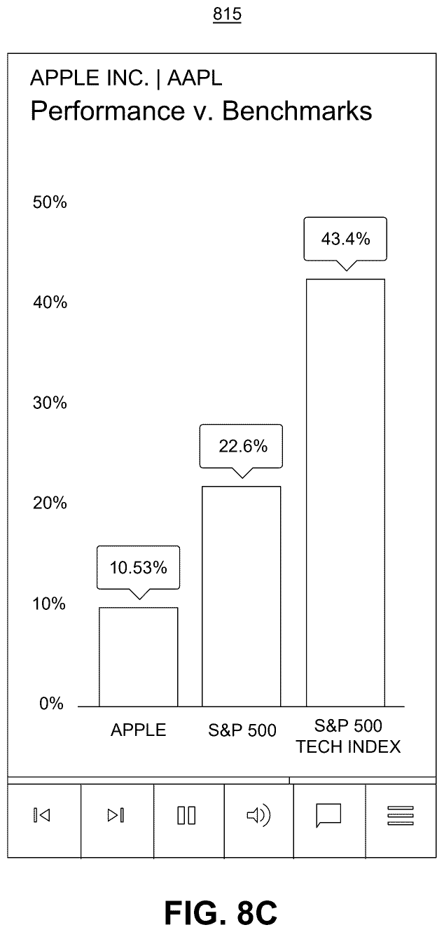

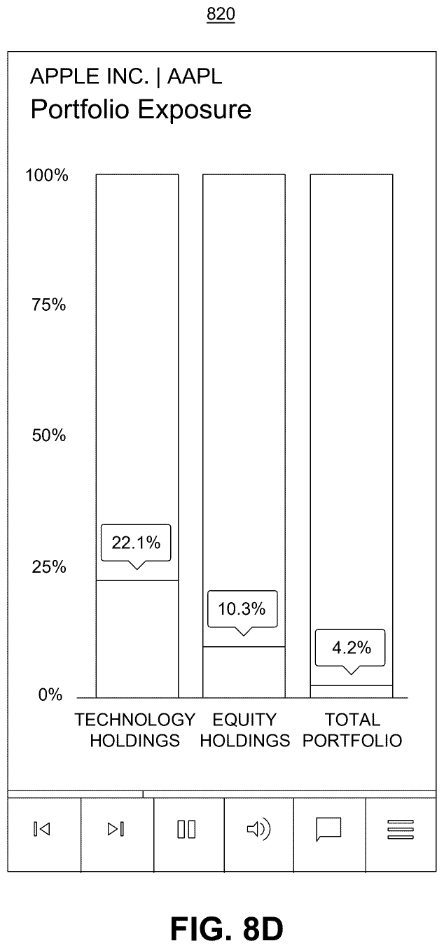

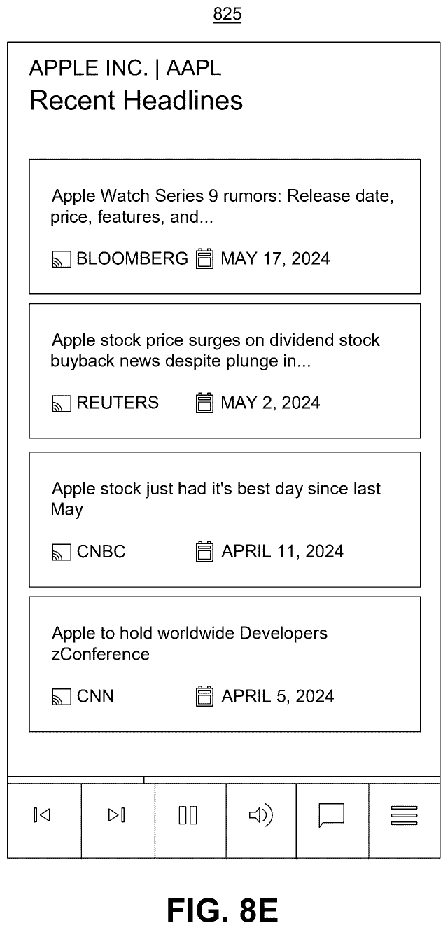

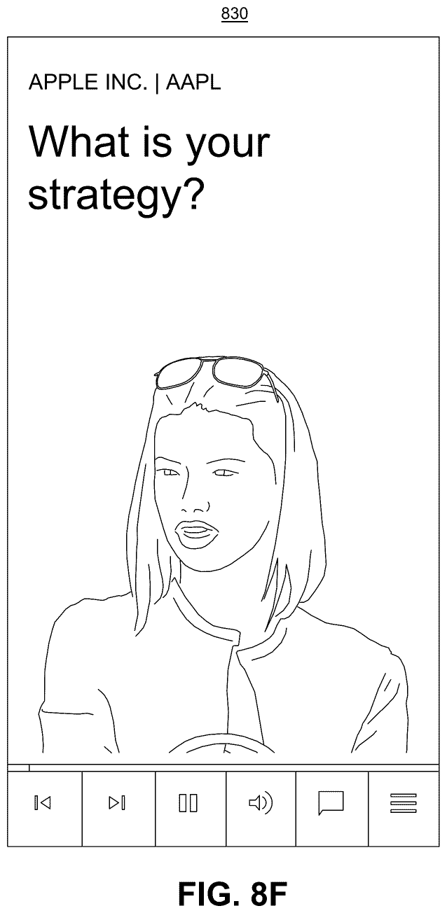

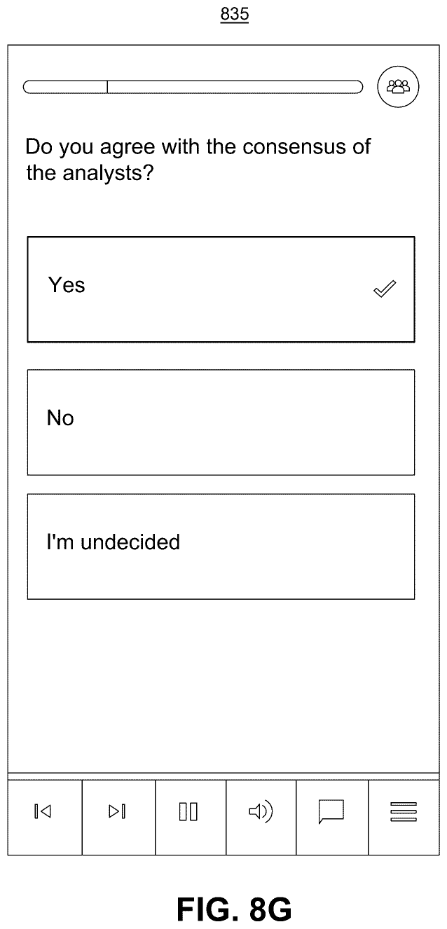

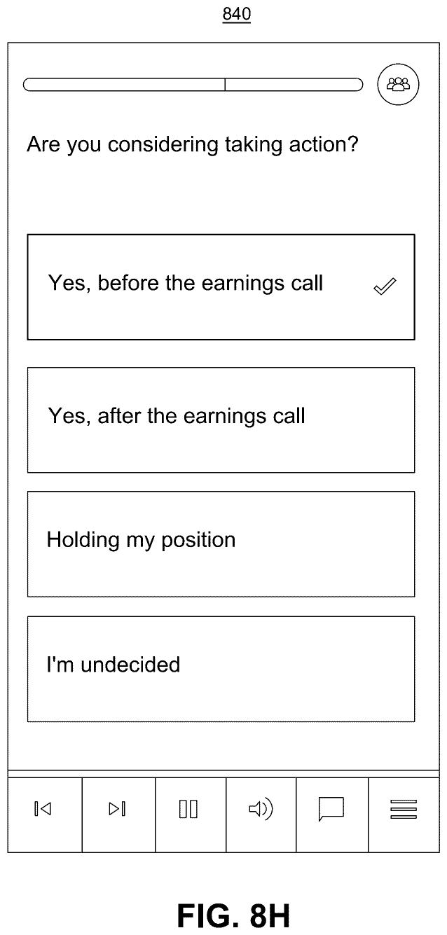

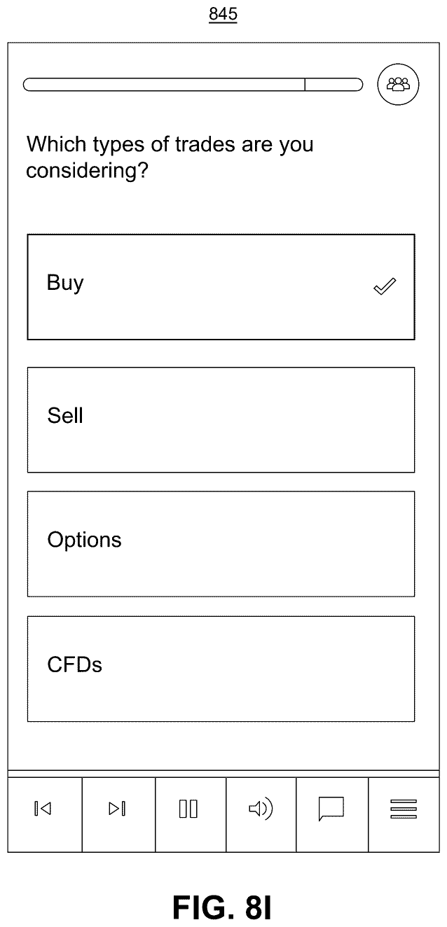

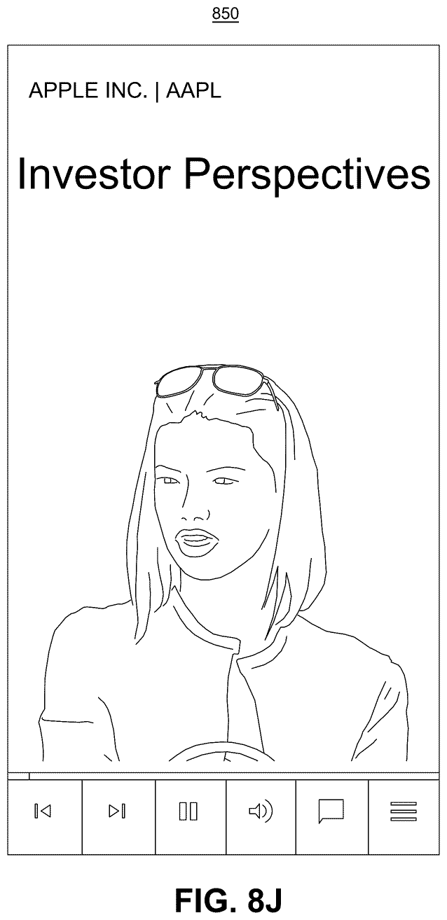

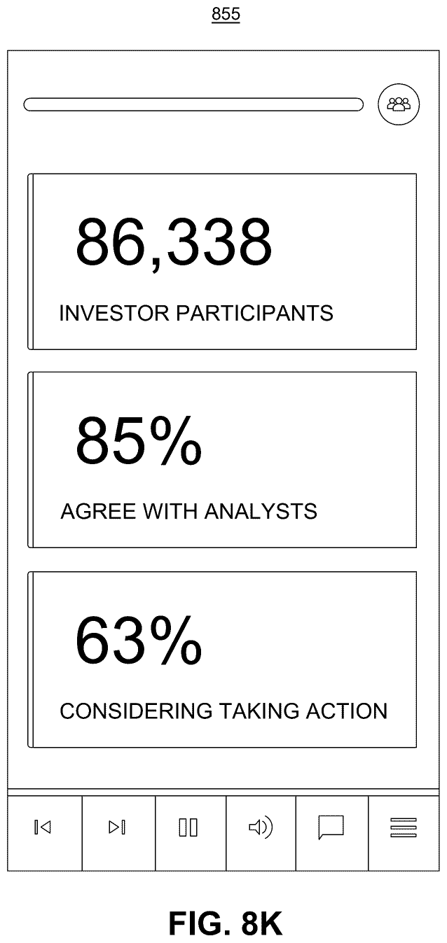

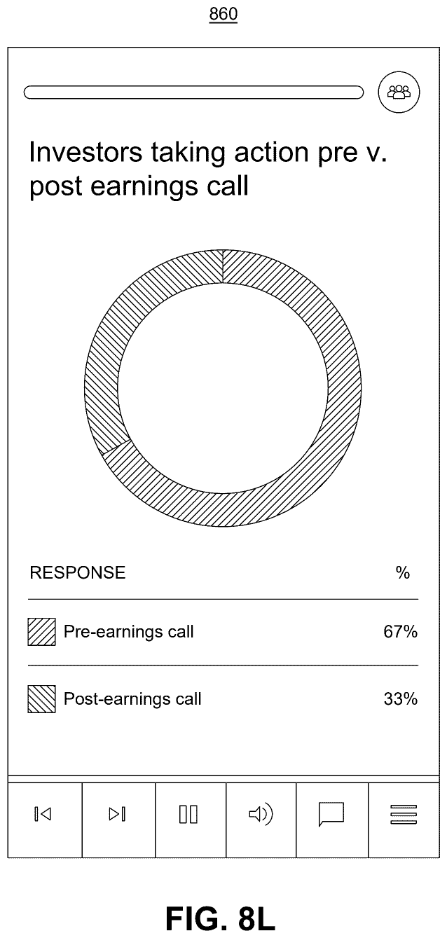

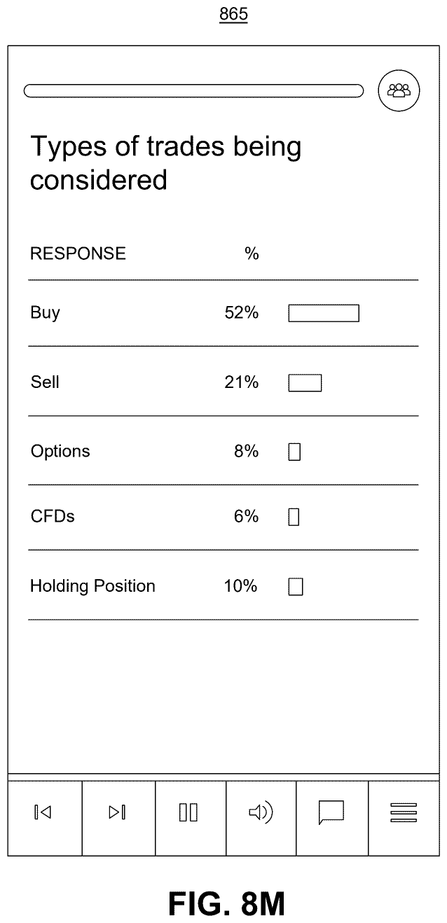

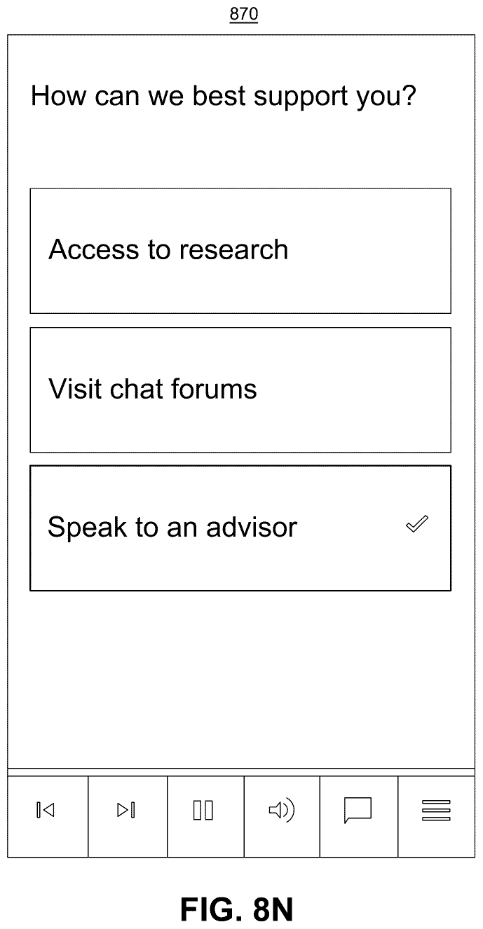

Before detailing the components of the episode generation system 100 further, let us turn to some examples of the episodes 230 that can be generated by the episode generation system 100. Referring to FIGS. 5A-5D, multiple example scenes that can be included as part of an example daily market brief episode are shown, in accordance with some aspects of the disclosure. Referring to FIGS. 6A-6B, multiple example scenes that can be included as part of an example insurance overview episode are shown, in accordance with some aspects of the disclosure. Referring to FIGS. 7A-7C, multiple example scenes that can be included as part of an example retail overview episode are shown, in accordance with some aspects of the disclosure. Finally, referring to FIGS. 8A-8N, multiple example scenes that can be included as part of an example earnings preview episode are shown, in accordance with some aspects of the disclosure.

FIG. 5A shows an example commodity performance scene 510 that can be included as part of the daily market brief episode. The commodity performance scene 510 can be created from a ranking slot generator of the slot generators 121, for example. The analytic engine subsystem 130 can generate results objects for the commodity performance scene 510 that include analytics containing specific values for the price of silver, platinum, gold, coffee, corn, brent crude, WTI crude, and soybeans; the performance over the last day in the price of silver, platinum, gold, coffee, corn, brent crude, WTI crude, and soybeans; and the performance year-to-date in the price of silver, platinum, gold, coffee, corn, brent crude, WTI crude, and soybeans (as of Oct. 18, 2024). The commodity performance scene 510 also includes visual elements in the form of bar graphs to show the performance over the last day in the price of silver, platinum, gold, coffee, corn, brent crude, WTI crude, and soybeans and the performance year-to-date in the price of silver, platinum, gold, coffee, corn, brent crude, WTI crude, and soybeans.

FIG. 5B shows an example exchange rate scene 520 that can be included as part of the daily market brief episode. The exchange rate scene 520 can be created from an information cards slot generator of the slot generators 121, for example. The analytic engine subsystem 130 can generate results objects for the exchange rate scene 520 that include analytics containing specific values for the EUR/USD exchange rate, the GBP/USD exchange rate, the USD/JPY exchange rate, and the USD/CHF exchange rate (as of Oct. 18, 2024). The exchange rate scene 520 also includes visual elements in the form of flag images (icons) associated with the currencies.

FIG. 5C shows an example industry group performance scene 530 that can be included as part of the daily market brief episode. The industry group performance scene 530 can also be created from the information cards slot generator of the slot generators 121, for example. The analytic engine subsystem 130 can generate results objects for the group performance scene 530 that include analytics containing specific values for the price performance of the health care equipment and services industry group of the S&P 500, the consumer durables and apparel group of the S&P 500, the media and entertainment group of the group of the S&P 500, the insurance group of the S&P 500, the energy group of the S&P 500, and the household and personal products group of the S&P 500 (as of Oct. 18, 2024). The health care equipment and services industry group of the S&P 500, the consumer durables and apparel group of the S&P 500, and the media and entertainment group of the group of the S&P 500 are shown as the best daily performers, and the insurance group of the S&P 500, the energy group of the S&P 500, and the household and personal products group of the S&P 500 are shown as the worst performers. The industry group performance scene 530 also includes visual elements in the form of flag images (icons) associated with the industry groups, and red/green colored arrows showing positive or negative performance.

FIG. 5D shows an example world market performance scene 540 that can be included as part of the daily market brief episode. The world market performance scene 540 can be created from the ranking slot generator of the slot generators 121, for example. The analytic engine subsystem 130 can generate results objects for the world market performance scene 540 that include analytics containing specific values for the price of the Hang Seng index, the Euro Stoxx index, the NASDAQ index, the S&P 500 index, the Swiss Market index, the Nikkei 225 index, the Dow Jones index, and the FTSE 100 index; the performance over the last day for the Hang Seng index, the Euro Stoxx index, the NASDAQ index, the S&P 500 index, the Swiss Market index, the Nikkei 225 index, the Dow Jones index, and the FTSE 100 index; and the performance year-to-date for the Hang Seng index, the Euro Stoxx index, the NASDAQ index, the S&P 500 index, the Swiss Market index, the Nikkei 225 index, the Dow Jones index, and the FTSE 100 index. The world market performance scene 540 also includes visual elements in the form of flag images (icons) associated with the world markets and bar graphs to show the performance over the last day for the Hang Seng index, the Euro Stoxx index, the NASDAQ index, the S&P 500 index, the Swiss Market index, the Nikkei 225 index, the Dow Jones index, and the FTSE 100 index and the performance year-to-date for the Hang Seng index, the Euro Stoxx index, the NASDAQ index, the S&P 500 index, the Swiss Market index, the Nikkei 225 index, the Dow Jones index, and the FTSE 100 index.

FIG. 6A shows an example incurred cost scene 610 that can be included as part of the insurance overview episode. The incurred cost scene 610 can be created from a multi-metric group-by slot generator of the slot generators 121, for example. The analytic engine subsystem 130 can generate results objects for the incurred cost scene 610 that include analytics containing specific values for incurred cost increases quarter over quarter for an insurance company. The incurred cost scene 610 also includes visual elements in the form bar graphs that show the incurred cost increases grouped by year. The incurred cost scene 610 can provide a user (e.g., an employee of the insurance company) to view incurred cost data quickly and efficiently via the bar graphs, as shown.

FIG. 6B shows an example open claims scene 620 that can be included as part of the insurance overview episode. The open claims scene 620 can be created from the ranking slot generator of the slot generators 121, for example. The analytic engine subsystem 130 can generate results objects for the open claims scene 620 that include analytics containing specific values for the employee (e.g., of the insurance company) associated with the claim, the date the claim was incurred, the number of days the claim has been open, the reserve amount of money associated with the claim, and the incurred cost of the claim, for two different claims identified as being the largest open claims for the insurance company. The open claims scene 620 also includes visual elements in the form of bar graphs to show the incurred cost for each of the largest open claims for the insurance company.

FIG. 7A shows an example brand ranking scene 710 that can be included as part of the retail overview episode. The brand ranking scene 710 can be created from the ranking slot generator of the slot generators 121, for example. The analytic engine subsystem 130 can generate results objects for the brand ranking scene 710 that include analytics containing specific values for sales volume, the percentage change in the sales volume, and the ranking (e.g., by sales volume for a given retailer) for six different brands (A-F) over the last 52 weeks compared to the previous 52 weeks. The brand ranking scene 710 also includes visual elements in the form of bar graphs to show percentage change in the sales volume for each of the brands.

FIG. 7B shows an example promotion optimization scene 720 that can be included as part of the retail overview episode. The promotion optimization scene 720 can be created from an action cards slot generator of the slot generators 121, for example. Each of the action cards in the promotion optimization scene 720 can be selectable by a user (e.g., by providing a user input via the user interface 242 on the computing device 240) to explore different avenues for promotion optimization to help improve retail sales volume. The promotion optimization scene 720 provides an example of interactive functionality that can be provided via the episodes 230, as detailed further below.

FIG. 7C shows an example growth trend scene 730 that can be included as part of the retail overview episode. The growth trend scene 730 can be created from a multi-review slot generator of the slot generators 121, for example. The analytic engine subsystem 130 can generate results objects for the growth trend scene 730 that include analytics containing specific values for the sales volume growth for two different brands over the last 52 weeks for a given retailer. The growth trend scene 730 then presents these analytics visually in the form of two line graphs. The growth trend scene 730 again provides an example of the interactive functionality that can be provided via the episodes 230, as the specific value for brand A in July of 2024 is shown via a text box when the user hovers over the specific data point on the line graph associated with brand A in July of 2024 (e.g., with a mouse pointer, via touch selection, etc.).

FIG. 8A shows an example introduction scene 805 that can be included as part of the earnings preview episode. The introduction scene 805 can be created from a title slot generator of the slot generators 121, for example. As shown, the introduction scene 805 includes a visual element in the form of an avatar 806 that can be synchronized with audio during the episode (e.g., introductory audio associated with the upcoming earnings event for Apple Inc.). The analytic engine subsystem 130 can generate results objects for the introduction scene 805 that include analytics containing any specific values noted in the audio provided as part of the audio associated with the introduction scene 805, for example.

FIG. 8B shows an example earnings estimates scene 810 that can be included as part of the earnings preview episode. The earnings estimates scene 810 can be created from the information cards slot generator of the slot generators 121, for example. The analytic engine subsystem 130 can generate results objects for the earnings estimates scene 810 that include analytics containing specific values for the projected revenue to be reported during the upcoming earnings event for Apple Inc. and the difference in the projected revenue to be reported during the upcoming earnings event for Apple Inc. compared to a prior period (e.g., compared to last quarter, compared to the same quarter last year, etc.). The analytic engine subsystem 130 can generate results objects for the earnings estimates scene 810 that include analytics containing specific values for the projected earnings per share to be reported during the upcoming earnings event for Apple Inc. and the difference in the projected earnings per share to be reported during the upcoming earnings event for Apple Inc. compared to a prior period (e.g., compared to last quarter, compared to the same quarter last year, etc.).

FIG. 8C shows an example performance comparison scene 815 that can be included as part of the earnings preview episode. The performance comparison scene 815 can be created from the group-by slot generator of the slot generators 121, for example. The analytic engine subsystem 130 can generate results objects for the performance comparison scene 815 that include analytics containing specific values for the price performance of Apple Inc. stock over the past year, the price performance of the S&P 500 index over the past year, and the price performance of the S&P 500 technology sector index over the past year. The performance comparison scene 815 also includes visual elements in the form of bar graphs to show the price performance of Apple Inc. stock compared to the benchmarks of the S&P 500 index over the past year, and the price performance of the S&P 500 technology sector index over the past year.

FIG. 8D shows an example portfolio exposure scene 820 that can be included as part of the earnings preview episode. The portfolio exposure scene 820 can be created from the group-by slot generator of the slot generators 121, for example. The analytic engine subsystem 130 can generate results objects for the portfolio exposure scene 820 that include analytics containing specific values for the percentage of equity holdings in the technology sector in a given investment portfolio that are allocated to Apple Inc., the percentage of total equity holdings in the investment portfolio that are allocated to Apple Inc., and the percentage of total assets in the investment portfolio that are allocated to Apple Inc. The portfolio exposure scene 820 also includes visual elements in the form of bar graphs to show the percentage of equity holdings in the technology sector in the investment portfolio that are allocated to Apple Inc., the percentage of total equity holdings in the investment portfolio that are allocated to Apple Inc., and the percentage of total assets in the investment portfolio that are allocated to Apple Inc.

FIG. 8E shows an example recent headlines scene 825 that can be included as part of the earnings preview episode. The recent headlines scene 825 can be created from the information cards slot generator of the slot generators 121, for example. The analytic engine subsystem 130 can query the external data 210 to retrieve the news articles as shown in the recent headlines scene 825 based on the episode configuration associated with the earnings preview episode (e.g., based on a parameterized slot cards generator, etc.). In this example, the analytic engine subsystem 130 can generate results objects for the recent headlines scene 825 that include analytics containing specific values for the news source (e.g., CNN, CNBC, etc.), the date associated with the articles, and/or links to the articles. The recent headlines scene 825 also includes visual elements in the form of interactive cards that can be selected by the user to view the associated articles.

FIG. 8F shows an example strategy introduction scene 830 that can be included as part of the earnings preview episode. The strategy introduction scene 830 can be created from the title slot generator of the slot generators 121, for example. As shown, the strategy introduction scene 830 includes a visual element in the form of an avatar (e.g., similar to the avatar 806) that can be synchronized with audio during the episode (e.g., strategy audio associated with the upcoming earnings event for Apple Inc.). The analytic engine subsystem 130 can generate results objects for the strategy introduction scene 830 that include analytics containing any specific values noted in the audio provided as part of the audio associated with the strategy introduction scene 830, for example.

FIG. 8G shows an example analyst consensus scene 835 that can be included as part of the earnings preview episode. The analyst consensus scene 835 can be created from a survey slot generator of the slot generators 121, for example. The analytic engine subsystem 130 can generate results objects for the analyst consensus scene 835 that include survey options (e.g., yes, no, undecided) for selection by the user via the analyst consensus scene 835. FIG. 8H shows an example action scene 840 that can be included as part of the earnings preview episode. The commodity action scene 840 can be created from the survey slot generator of the slot generators 121, for example. The analytic engine subsystem 130 can generate results objects for the action scene 840 that include survey options (e.g., yes-before the earnings, yes-after the earnings call, holding, undecided) for selection by the user via the analyst consensus scene 835. FIG. 8I shows an example trade types scene 845 that can be included as part of the earnings preview episode. The trade types scene 845 can be created from the survey slot generator of the slot generators 121, for example. The analytic engine subsystem 130 can generate results objects for the trade types scene 845 that include survey options (e.g., buy, sell, options, contract for difference (CFD)) for selection by the user via the analyst consensus scene 835.

FIG. 8J shows an example investor perspectives scene 850 that can be included as part of the earnings preview episode. The investor perspectives scene 850 can be created from the title slot generator of the slot generators 121, for example. As shown, the investor perspectives scene 850 includes a visual element in the form of an avatar (e.g., similar to the avatar 806) that can be synchronized with audio during the episode (e.g., investor perspectives audio associated with the upcoming earnings event for Apple Inc.). The analytic engine subsystem 130 can generate results objects for the investor perspectives scene 850 that include analytics containing any specific values noted in the audio provided as part of the audio associated with the investor perspectives scene 850, for example. The audio associated with the investor perspectives scene 850 can provide feedback to the user based on the survey answers entered via the analyst consensus scene 835, the commodity action scene 840, and/or the trade types scene 845, for example.

FIG. 8K shows another example investor perspectives scene 855 that can be included as part of the earnings preview episode. The investor perspectives scene 855 can be created from the title slot generator of the slot generators 121, for example. The analytic engine subsystem 130 can generate results objects for the investor perspectives scene 855 that include analytics containing specific values for a number of total investor participants (e.g., in survey(s) associated with the earnings event for Apple Inc.), a percentage of the total investor participants that agree with the consensus of the analysts covering Apple Inc., and a percentage of the total investor participants that are considering acting on Apple Inc. (e.g., via one or more trades).

FIG. 8L shows an example investor actions scene 860 that can be included as part of the earnings preview episode. The investor actions scene 860 can be created from the group-by slot generator of the slot generators 121, for example. The analytic engine subsystem 130 can generate results objects for the investor actions scene 860 that include analytics containing specific values for a percentage of the total investor participants that are considering acting on Apple Inc. before the upcoming earnings call and a percentage of the total investor participants that are considering acting on Apple Inc. after the upcoming earnings call. The investor actions scene 860 also includes visual elements in the form of a pie chart to show the percentage of the total investor participants that are considering acting on Apple Inc. before the upcoming earnings call and the percentage of the total investor participants that are considering acting on Apple Inc. after the upcoming earnings call.

FIG. 8M shows another example trade types scene 865 that can be included as part of the earnings preview episode. The trade types scene 865 can be created from the group-by slot generator of the slot generators 121, for example. The analytic engine subsystem 130 can generate results objects for the trade types scene 865 that include analytics containing specific values for a percentage of the total investor participants that are considering buying Apple Inc. around the upcoming earnings call, a percentage of the total investor participants that are considering selling Apple Inc. around the upcoming earnings call, a percentage of the total investor participants that are considering trading options on Apple Inc. around the upcoming earnings call, a percentage of the total investor participants that are considering trading CFDs on Apple Inc. around the upcoming earnings call, and a percentage of the total investor participants that are considering holding Apple Inc. through the upcoming earnings call. The trade types scene 865 also includes visual indicators in the form of bar graphs showing the percentage of the total investor participants that are considering buying Apple Inc. around the upcoming earnings call, the percentage of the total investor participants that are considering selling Apple Inc. around the upcoming earnings call, the percentage of the total investor participants that are considering trading options on Apple Inc. around the upcoming earnings call, the percentage of the total investor participants that are considering trading CFDs on Apple Inc. around the upcoming earnings call, and the percentage of the total investor participants that are considering holding Apple Inc. through the upcoming earnings call.

FIG. 8N shows an example support scene 870 that can be included as part of the earnings preview episode. The support scene 870 can be created from the action cards slot generator of the slot generators 121, for example. The analytic engine subsystem 130 can generate results objects for the support scene 870 that include analytics containing specific values that include survey options (e.g., access to research, visit chat forums, speak to an advisor) for selection by the user via the support scene 870. Based on a selection of any of the survey options by the user, the episode generation system 100 can initiate an appropriate action (e.g., providing a link to research, providing a link to a chat forum, scheduling a call with an advisory, etc.).

Referring back to FIG. 1, the data ingestion subsystem 110 can generally be configured to ingest the external data 210 into the episode generation system 100 from a variety of sources. The data ingestion subsystem 110 can ingest the external data 210 using a variety of different ingestion patterns. For example, the data ingestion subsystem 110 can ingest the external data 210 using API pull requests (polling), webhook pushes, file transfer protocol (FTP) triggers, data payloads inline with generation requests, and/or other types of ingestion patterns (e.g., other types of push/pull/polling requests). The external data 210 ingested by the data ingestion subsystem 110 can include structured data (e.g., JavaScript Object Notation (JSON) data, comma-separated values (CSV) data, Structured Query Language (SQL) data, etc.) and semi-structured or un-structured data (e.g., Portable Document Format (PDF) files, etc.).

The data ingestion subsystem 110 can allow the episode generation system 100 to ingest and make use of semi-structured and un-structured data in various ways. For example, the data ingestion subsystem 110 can use various template matching techniques to extract data from semi-structured and un-structured data (e.g., a PDF file containing text for ingestion into the episode generation system 100, etc.). In some cases, the data ingestion subsystem 110 can request input from a human (e.g., “human in the loop”) to review results of data ingestion from semi-structured and un-structured data to ensure that the data ingestion subsystem 110 performs the extraction accurately (e.g., when a confidence level is below a threshold). Additionally, the data ingestion subsystem 110 can interface with the artificial intelligence systems 220 and the models 222 (e.g., a large language model) to facilitate extraction of text from semi-structured and un-structured documents.

The data ingestion subsystem 110 can ingest data for use by the episode generation system 100 in accordance with various pattern types. For example, the data ingestion subsystem 110 can ingest and generate data for use by the episode generation system 100 ahead of time (e.g., before receiving a request to generate an episode) in accordance with a scheduled or triggered process (e.g., triggered when new data is available for ingestion, etc.). Also, the data ingestion subsystem 110 can ingest data for use by the episode generation system 100 “just in time” (e.g., the data ingestion subsystem 110 can ingest and generate data for use by the episode generation system 100 responsive to receiving a request to generate an episode or via data included in full or in part in the request to generate the episode). The data ingestion subsystem 110 can also ingest data for use by the episode generation system 100 in a “content-included” manner (e.g., the data ingestion subsystem 110 can ingest data for use by the episode generation system 100 in accordance with images, data, voiceover language, etc. as provided by a user of the episode generation system 100 to generate scenes). The data ingestion subsystem 110 can ingest and generate data in a variety of different domains, including retail, insurance, stock markets, gaming, portfolio commentary, sales, bookkeeping, education, real estate, finance, and others, for example.

The domain modeling subsystem 115 can generally be configured to model the data ingested by the data ingestion subsystem 110 and map the external data 210 that is ingested by the data ingestion subsystem 110 to one or more specific domains. For example, the domain modeling subsystem 115 can map the external data 210 that is ingested by the data ingestion subsystem 110 into a specific format such that the external data 210 that is ingested by the data ingestion subsystem 110 is recognizable and manipulatable by the other components of the episode generation system 100. To perform this mapping, the domain modeling subsystem 115 can apply the external data 210 that is ingested by the data ingestion subsystem 110 to one or more semantic data models that define one or more domains (e.g., finance, insurance, retail, etc.) associated with the external data 210 that is ingested by the data ingestion subsystem 110.

The domain modeling subsystem 115 can use various data mappings from domain graphs to underlying data schemas to transform the external data 210 that is ingested by the data ingestion subsystem 110 into a recognizable format such that the external data 210 that is ingested by the data ingestion subsystem 110 can be queried by the other components of the episode generation system 100. The domain graphs and data mappings maintained by the domain modeling subsystem 115 can be updated and fine tuned over time for different domains to provide more dynamic data semantics for different domains as knowledge regarding the domains improves. Furthermore, the data mappings maintained by the domain modeling subsystem 115 can specify how to connect to multiple datasets in the domain graph (e.g., which tables to utilize for a given entity in the domain graph), enabling database analyses across multiple databases and managing that abstraction such that downstream the rest of the architecture does not need to manage handling multiple databases. The ability to add data semantics in this manner to any of a variety of types of external data that may be ingested by the episode generation system 100 can allow any of a variety of types of entities in any of a variety of types of domains to connect data to the episode generation system 100 to utilize the functionality provided by the episode generation system 100.

The episode configuration subsystem 120 can generally be configured to define, provide, and generate various configurations used by the episode generation system 100. The episode configuration subsystem 120 can provide functionality that allows the episode generation system 100 to be configuration-driven as several key points using artifacts (e.g., JSON artifacts). For example, the slot generators 121 can include generalized analytic specifications for components of the episodes 230 (e.g., for content to be conveyed via the episodes 230). One example of the slot generators 121 can include a “rank” slot generator, which focuses on ranking elements based on a set of metrics along with supporting facts (e.g., the highest or lowest value of that metric, the difference in value of that metric from highest to lowest, rankings of the same elements based on supporting metrics, etc.), along with facts that are reactive to the domain elements of a given instantiation of the “rank” slot generator (e.g. rankings of the same elements based on supporting metrics, changes in ranking over time, etc.). The slot generators 121 can include and define various parameters associated with a given scene in the episodes 230. As another example, referring back to the example exchange rate scene 520, the slot generators 121 can include a particular slot generator (e.g., the information cards slot generator) that defines and includes the parameters shown in FIG. 5B, including the EUR/USD exchange rate, the GBP/USD exchange rate, the USD/JPY exchange rate, and the USD/CHF exchange rate in the form of populated information cards.

The parameters used to define the scope and shape of content in the configurations managed by the episode configuration subsystem 120 can be provided in the configuration itself (e.g., as noted above with respect to the example exchange rate scene 520), provided in the episode generation request (e.g., the selection of which currencies to cover could be passed into the episode generation system 100 with the generation request), or derived by an earlier component in the execution runtime (e.g., in a different domain, a follow up scene could be parameterized to be “about” the top product in a prior scene's ranking).

The slot templates 122 can then include a specification for a scene of the episodes 230, or a component of a scene the episodes 230. For example, the slot templates 122 can include one or more of the slot generators 121, a visual specification, and a narration configuration. The scene templates 123 can then include frames for one or more of the slot templates 122 that work in conjunction with each other to form a given scene in the episodes 230. Similarly, the sections 124 can include a set of one or more scenes in the episodes 230 as defined by the scene templates 123 that have shared context and/or shared parameterization (e.g., as defined by one or more of the slot generators 121). The iterators 125 can then include optional elements that iterate over a set of parameters that spawn one or more of the sections 124 or one or more of the scenes as defined by the scene templates 123.

The script templates 126 (“outlines”) can then include a set of one or more of the sections 124, and in some cases one or more of the iterators 125. The script templates 126 can also include a script-level configuration that defines, for example, a default voice selection and a definition of the particular parameters that will be used when an episode request is received (e.g., client identified, brand name, portfolio number, etc.). The script templates 126 can be delivered in multiple forms, including as audio/video episodes, rendered as documents (e.g., as an episode addendum or “takeaway”), as podcasts, and dashboard-like incarnations (“storyboards”), among other possibilities. In some examples, the script templates 126 can be used to embed video in the episodes 230 by reference (e.g., to embed an opening statement from a portfolio manager, etc.). The episode templates 127 can then include links between particular users of the episode generation system 100 (e.g., organizations) and the script templates 126. The episode templates 127 can, in some examples, override settings defined by the script templates 126 (e.g., palette selection, voice selection, etc.) to provide default parameterizations on a per-user basis.

Finally, the series 128 can include wrappers around one or more of the episode templates 127 to provide an episodic generation in a thread. For example, the series 128 can provide episodic generation based on triggers or based on a pre-defined schedule, with an awareness of the “latest” available episode and one or more additional features (e.g., viewing history, generation history, etc.). The design of the episode configuration subsystem 120 can allow for highly configurable and adaptable episode generation functionality within the episode generation system 100. The configurations defined by the slot generators 121, the slot templates 122, the scene templates 123, the sections 124, the iterators 125, the script templates 126, the episode templates 127, and the series 128 can be defined and included in one or more JSON configuration files, for example, that are digestible by the other components of the episode generation system 100.

The analytic engine subsystem 130 can generally ingest the configurations defined by the episode configuration subsystem 120 to compile and run the configurations defined by the episode configuration subsystem 120 to produce results objects. The analytic engine subsystem 130 can ingest the configurations defined by the episode configuration subsystem 120 to produce results objects on a per slot or per scene level to support the rendering of visualizations, language, and events within the episodes 230. Based on the episode configurations received from the episode configuration subsystem 120, the analytic engine 130 can, in some example, perform one or more “preflight checks” ahead of results object generation to validate availability and consistency of associated data. In the event of validation failure, the analytic engine subsystem 130 can emit a failure state.

The data wrapper 131 can include a specific library that compiles domain and mapping configurations into an interface that can convert the internal representations of the analytic engine subsystem 130 into queries (e.g., SQL queries) against databases of varying schemas. This functionality can allow the episode generation system 100 to abstract the particulars of any given schema away and thereby allow the episode generation system 100 to “speak” in the language of the ontological objects. As such, the analytic engine subsystem 130 can flexibly generate and run queries flexibly across disparate datasets and domains. The data wrapper 131 can also leverage the domain and mapping configurations to efficiently retrieve data via queries depending on the requirements of that query and the available data (e.g., if a database contains tables with pre-aggregated metrics at different levels of granularity, the data wrapper 131 can determine which one to utilize and “shortcut” the analysis while still maintaining the semantic representation of the result).

The story types 132 can include a library of different types at different granularities. For example, the story types 132 can include and define base types (e.g., semantically relevant types) to support common operations such as intelligent number rounding (e.g., standard, user preferred, etc.), pluralization of nouns, and subject-verb agreement, for example. The story types 132 can also include and define object types (e.g., a hierarchy of the script templates 126, the sections 124, the scene templates 123, the slot templates 122, etc.) with instantiation from configurations that are generated by the episode configuration subsystem 120 (e.g., JSON configurations), validators, helper methods, and exports (e.g., to JSON, for rendering downstream). The story types 132 can also include a pronunciation library that contains terms of art and proper nouns for certain organizations, for example. The story analytics 133 can include a library of analytic components that can be invoked and chained in the context of the slot generators 121. The scripting language 134 can be a scripting language used to define the slot generators 121 in a JSON configuration that leverages components of the story types 132 and the story analytics 133.

The summaries 135 can include content summaries that are generated by the analytic engine subsystem 130 based on the configurations defined by the episode configuration subsystem 120. For example, the summaries 135 can summarize content within the slot templates 122, across the scene templates 123, and rolling up to the episodes 230 (and/or any supporting documentation). The summaries 135 can also be used for “recursive” summarization, such as summarizing one of the episodes 230 into a single scene, for example. The summaries 135 can output results objects with the same structure as those of the analytic engine subsystem 130, enabling the summaries 135 to recursively summarize scenes, sections, episodes, and series into components for new episodes from those summaries. The weights 136 can be used to weigh certain information for prioritization within the episodes 230. The history analyzer 137 can be used to “look back” across one or more of the series 128 to discover previously conveyed information for the sake of future content generation (e.g., “as was mentioned in the previous episode . . . ”). The runtime compiler 138 can then be used to compile the various configurations generated by the episode configuration subsystem 120 leveraging the data wrapper 131, the story types 132, the story analytics 133, the scripting language 134, the summaries 135, the weights 136, and the history analyzer 137 to produce the results objects. The analytic engine subsystem 130 can also optimize queries to retrieve the external data 210 as needed for the episodes 230.

The episode production subsystem 140 can generally be configured to take the results objects generated by the analytic engine subsystem 130 as embedded in the configurations defined by the episode configuration subsystem 120 (e.g., script/outline hierarchy) to produce episode data packages that can be used by the episode player subsystem 160 to play the episodes 230. The episode data packages can include, for example, scripts for the episodes 230 (e.g., JSON files) and any associated media assets (e.g., voiceover files, embedded videos, customization, etc.) that can be interpreted by the episode player subsystem 160 to play the episodes 230. In some cases (e.g., when certain types of insights are derived, when certain types of trigger conditions are met, when an awareness of what the viewer has or has not already seen in previous episodes alters the content focus and/or requirements, when states in the data are sufficiently different from the requirements, when a preflight check fails, etc.) the episode production subsystem 140 can implement alternative episode production strategies available as defined in the episode configuration subsystem 120. In such cases, the resulting episode can be substantially or entirely different in scope or focus, include alternative scenes, or include a single preflight check scene that alerts the viewer to deficiencies in the available data, for example.

The organizer 141 (“outliner”) in particular can be configured to organize information that is associated with the slot generators 121 (e.g., by leveraging weighting and outcomes of insight generated by the analytic engine subsystem 130). In some examples, the organizer 141 can omit elements defined by the slot generators 121 or opt to skip entire scenes (as defined by the scene templates 123) or sections 124. The language generator 142 can be configured to generate natural language for inclusion in the episode 230 in various suitable manners. For example, the language generator 142 can use composable templates to generate language for inclusion in the episodes 230. The composable templates can be advantageous in that they allow the language generation functionality performed by the language generator 142 to be 100% deterministic and traceable. Additionally, the language generator 142 can interface with the artificial intelligence systems 220 and the models 222 to generate language for inclusion in the episodes 230.

For example, the language generator 142 can interface with one or more large language models to generate language for inclusion in the episodes 230. In such examples, the language generator 142 can provide prompts to the artificial intelligence systems 220 that include discrete facts as generated by the analytic engine subsystem 130 (e.g., as contained in the results objects). As a result, the prompts provided by the language generator 142 to the one artificial intelligence systems 220 can be constrained to a particular context window. Further, the language generator 142 can fact check the outputs returned by the artificial intelligence systems 220 (e.g., by comparing the outputs to expected outputs) to ensure that no information was altered or lost during the use of the artificial intelligence systems 220. The language generator 142, using these approaches, can generate narration scripts that include the language for the episodes 230. The language generator 142 can augment the narration scripts with phonetic pronunciations, in some examples. Further, the analytic engine subsystem 130 can provide support for any suitable human language (e.g., Spanish, French, English, etc.). For example, the language generator 142 can leverage the outputs of the analytic engine subsystem 130 and/or other parameter inputs coupled with optional additional language configurations associated with the domain modeling subsystem 115 and, depending on the language generation approach, use templates and/or the models 222 to natively generate narration scripts in multiple languages from the same analytic and semantic ground truth. These alternative narration scripts can be passed through alternative models during voiceover generation within the context of the media service 143, for example. Accordingly, using the results objects generated by the analytic engine subsystem 130, the language generator 142 can generate language in any suitable human language.

The media service 143 can be configured to request and generate various types of media assets associated with the episodes 230. For example, the media service 143 can be configured to generate voiceover using the narration scripts that are generated by the language generator 142. To do so, the media service 143 can interface with the artificial intelligence systems 220 and the models 222 (e.g., one or more voiceover models) to generate voiceover to accompany the narration scripts. The voiceover can include audio contained in audio files (e.g., MPEG-1 Audio Layer-3 (MP3) files), for example. The media service 143 can also generate various types of avatars for inclusion within the episodes 230 (e.g., “talking heads” as shown in the example introduction scene 805 in FIG. 8A, or other types of avatars). The avatars can provide a human element to the presentation of the episodes 230 and, in some examples, the media service 143 can generate the avatars by interfacing with the artificial intelligence systems 220 and the models 222. The media assets generated by the media service 143 can also include content for embedding within the episodes 230. For example, the media service 143 can provide support for embedding MPEG-4 Part 14 (MP4) video files within the episodes 230 for playback. The video files can be pre-recorded video files (e.g., an introductory statement from a CEO of a wealth management firm), or can be more nascent video files generated by the episode generation system 100 and/or the artificial intelligence systems 220 and the models 222. The media service 143 can also generate links to various types of content for inclusion in the episodes 230 (e.g., links to news articles, links to videos, links to images, etc.). The media service 143 can support signed Uniform Resource Locators (URLs) that expire after a small timeframe (e.g., 30 minutes).

The narrator 144 can be configured to add tags to the narration scripts generated by the language generator 142 and/or the media assets generated by the media service 143. For example, the narrator 144 can add tags (e.g., timestamps, etc.) to certain phrases and/or sentences in the narration scripts generated by the language generator 142 to help associate the narration scripts generated by the language generator 142 with relevant visualization components (e.g., media assets generated by the media service 143, etc.) to enable synchronization of the language for the episodes 230 with the visualizations for the episodes 230. Additionally, the narrator 144 can also add tags (e.g., timestamps, etc.) to audio files (e.g., MP3 voiceover files) to help associate the audio files with the narration scripts and/or relevant visualization components for the episodes 230. The narrator 144 can interface with the artificial intelligence systems 220 and the models 222 to generate timestamps (e.g., using forced alignment) associated with each word or with groups of words in the audio voiceover files associated with the narration scripts. For example, the narrator 144 can interface with the artificial intelligence systems 220 and the models 222 (e.g., one or more voiceover models) to generate voiceover to accompany the narration scripts.

The orchestrator 145 can be configured to synchronize (“orchestrate”) the tags applied to the narration scripts by the narrator 144, the tags applied to the audio files (e.g., voiceover files) by the narrator 144, and/or the tags applied to the media assets generated by the media service 143. For example, the orchestrator can match timestamps associated with the narration scripts to timestamps associated with the audio files. As such, the orchestrator 145 can create orchestration events for each scene in the episodes 230 for inclusion in the episode data packages (e.g., in a log) provided to the episode player subsystem 160, such that the episode player subsystem 160 can interpret the orchestration events to synchronize the playback of the episodes 230.

The visualizer 146 can be configured to generate visualization specifications for the episodes 230 for inclusion in the episode data packages provided to the episode player subsystem 160 such that the episode player subsystem 160 can appropriately render the visualizations defined by the visualization specifications during the playback of the episodes 230 using the episode data packages generated by the episode production subsystem 140. For example, the visualizer 146 can generate the visualizations for the episodes 230 in accordance with the script templates 126 and based on the results objects generated by the analytic engine subsystem 130. The visualizations can include various visual elements such as bar graphs (e.g., as shown in the example performance comparison scene 815 in FIG. 8C), line charts (e.g., as shown in the example growth trend scene 730 in FIG. 7C), data tables (e.g., as shown in the example commodity performance scene 510 in FIG. 5A), interactive elements (e.g., as shown in the example action scene 840 in FIG. 8H), and other types of visualizations. The visualizer 146 can be configured to generate the visualizations as defined in accordance with the episode configurations defined by the episode configuration subsystem 120 and episode customization subsystem 150. For example, the slot generators 121 can define one or more visualization configurations associated with a particular scene. Additionally, the visualization specifications generated by the visualizer 146 can be styled (themed) in accordance with the episode configurations defined by the episode configuration subsystem 120. The visualizer 146 can also organize theme assets (e.g., colors, fonts, layouts, backgrounds, etc.) based on pre-defined configurations (e.g., defined by the episode configuration subsystem 120) at different scopes (e.g., global, organization, episode, etc.) and factoring in any MSP-related inputs.

The asset generator 147 can be configured to output various types of assets (e.g., files, etc.) associated with the episodes 230 that can be either accessed by users of the episode generation system 100 or provided to the episode player subsystem 160. For example, the asset generator 148 can generate an output for providing to the episode player subsystem 160 (e.g., an episode data package) that includes (i) one or more audio files (e.g., MP3 files) and one or more text files (e.g., JSON files) containing all relevant scene data and metadata, layout settings, scripts event markers, and any other elements for playing the episode (e.g., transitions, lengths, etc.). Additionally, the asset generator 148 can generate MP4 files for any of the episodes 230 that can be accessed in various ways by users of the episode generation system 100. Further, the asset generator 147 can generate various types of files that serve as addendums to the episodes 230 that can be accessed in various ways by users of the episode generation system 100. For example, the addendums can include slide decks (e.g., in a PDF file, a PowerPoint file, etc.) that contain the scenes in the episodes 230. The addendums can also include the summaries 135 (e.g., main bullet points from the episodes that can be sent via electronic mail, etc.) and any other suitable types of addendum files. Additionally, the asset generator 147 can generate podcast files that contain the audio (and potentially the video) associated with the episode 230. The asset generator 147 can also register media assets (e.g., MP3 files, MP4 files, images, etc.) for inclusion in the episodes 230, including any media assets that are pre-generated and passed into the runtime of the episode generation system 100 and/or links or other types of references to media assets (e.g., as provided via the media service 143). In this sense, some of the functionality described as being part of the media service 143 and the asset generator 147 can overlap.

Additionally, the asset generator 147 can generate and produce diagnostic scripts that detail how the episode data packages were generated (e.g., queries run by the analytic engine subsystem 130, how language and visualization specifications were generated by the episode production subsystem 140, etc.). The diagnostic scripts can be stored in the system data 190 and retained in accordance with various policies (e.g., as configured via the episode customization subsystem 150). The diagnostic scripts can be used for compliance purposes and can ensure that the episode generation system 100 generates the episodes 230 in a deterministic manner. For example, in highly regulated industries (e.g., financial, insurance, etc.), the diagnostic scripts can be used to provide traceability and documentation as to how the episode generation system 100 produced any and all of the episodes 230.

The episode customization subsystem 150 can generally be configured to implement various stylistic choices and preferences within the episodes 230. For example, the episode customization subsystem 150 can be used to implement theming with the episodes 230 in various manners. The elements of this theming can include voice settings (e.g., language, gender, accent, speed, etc.), background music, a color palette (e.g., base colors, accent colors, etc.), background images, background animations, background videos, scene transition styles, fonts, and content layouts. The theming implemented by the episode customization subsystem 150 can be configured at a variety of granularities. For example, the episode customization subsystem 150 can define and implement a universal (“base”) theming. The episode customization subsystem 150 can also implement per-organization or per-user theming, per-episode theming, and per-scene theming. The episode customization subsystem 150 can interact with the episode production subsystem 140 (e.g., via the visualizer 146) to manage visualization specifications for the episodes 230.

Additionally, the episode customization subsystem 150 can implement dynamic theming (“multi-sensory personalization”) in various manners. That is, in some examples, the episode customization subsystem 150 can dynamically adjust various theming elements (e.g., music, voice, background images, etc.) with the episode templates 127 based on viewing audience factors. For example, for a portfolio review episode (e.g., containing one or more scenes similar to the portfolio exposure scene 820 shown in FIG. 8D), the episode customization subsystem 150 can adjust theming elements such as voice settings, background music, and/or background images based on the demographics of the viewer and/or the preferences of the viewer (e.g., dark mode, light mode, etc.). The ability to provide this dynamic theming as provided by the episode customization subsystem 150 can allow for improved engagement and enjoyment in terms of consumption of the episodes 230.

The episode customization subsystem 150 can also be configured to generate and provide different user interfaces that allow users to manage various aspects of the episodes 230. A user can access these user interfaces provided by the episode customization subsystem 150 via the user interface 242 on the computing device 240. For example, the episode customization subsystem 150 can generate and provide a “soundstage” user interface that serves as an episode testbed and allows users to create custom episodes (e.g., by selecting scene types, entering analytic data elements, writing narrations scripts, defining events, etc.) using the episode generation system 100. The episode customization subsystem 150 can also generate and provide a “studio” user interface that allows users of the episode generation system 100 to manage and configure any aspects of the episode configuration subsystem 120, including interstitial representations of various pipeline components for testing, review and optional inclusion in downstream episode generations. The episode customization subsystem 150 can also generate and provide an “episode creator” user interface that allows users of the episode generation system 100 to manage and configure any aspects of the data ingestion subsystem 110, the domain modeling subsystem 115, and the episode configuration subsystem 120.

Additionally, the episode customization subsystem 150 can generate and provide user interfaces that allow users of the episode generation system 100 to manage the creation and distribution of the episodes 230. For example, these user interfaces provided by the episode customization subsystem 150 can be used to configure schedules and triggers (e.g., triggers such as user interaction, API calls, events in the data, etc.) that control the generation and distribution of the episodes 230. The episode customization subsystem 150 can also allow for campaign style, batch generation of the episodes 230, controlling of access (e.g., per user, per organization, etc.) to the episodes 230, and various other parameters associated with the episode generation system 100. The episode customization subsystem 150 can allow users to configure provision of one-off (standalone) episodes, episode campaigns (e.g., a one-time batch of episodes), episode series (e.g., the series 128, a structured series of multiple related episodes), collections (e.g., a set of episodes that cover different areas of the same viewer's interest, such as retailers, categories, and promotions around the same brand). Further, the episode customization subsystem 150 can allow users to configure various security parameters associated with episodes (e.g., two-factor authentication, etc.), among other parameters associated with the episode generation system 100.

The episode player subsystem 160 can generally be configured to ingest the outputs of the episode production subsystem 140 (e.g., the episode data packages) and cause the episodes 230 to be presented (e.g., via the user interface 242 on the computing device 240, by requesting and retrieving the episodes 230 from the episode generation system 100 via the APIs 180, etc.). For example, for a given episode, the episode production subsystem 140 can generate an output that includes one or more audio files (e.g., MP3 files) and one or more text files (e.g., JSON files) containing all relevant scene data and metadata, layout settings, scripts event markers, and any other elements for playing the episode (e.g., transitions, lengths, etc.). The episode player subsystem 160 can then take that output of the episode production subsystem 140 and use it to play the episode. In some examples, the episode player subsystem 160 can be implemented as a JavaScript library that can be embedded on any website or other type of web application. Accordingly, the episode player subsystem 160 can be uniquely implemented as a library with specific requirements around how to interpret the episode data packages generated by the episode production subsystem 140, such that the episode player subsystem 160 is not simply loading a video file (e.g., an MP4 file) or a string of video files. Instead, the episode player subsystem 160 can play back the episodes 230 by drawing the components using Scalable Vector Graphics (SVG), for example, which can enable more dynamic playback and interactivity for the episodes 230.

The specific design of the episode player subsystem 160 provides a unique approach to implementing a “video-like” player that provides support for alternative modalities and features based on the same underlying diagnostic script (thereby enabling consistency across modalities). For example, the design of the episode player subsystem 160 can enable functions such as “export scene to PDF” or a “storyboard” layout where all scenes for a given episode can be presented in a grid/table for viewing as a “playable dashboard” interface, where each scene could be interacted with and played individually, and/or where the whole episode could be played back across the scene grid. Further, based on customizations configured via the episode customization subsystem 150, the episode player subsystem 160 can invoke additional security steps in conjunction with the APIs 180 before loading privileged episodes into client environments (e.g., the episode player subsystem 160 can provide an email input that, when submitted, validates access of the entered email to the given episode with the API that then causes an email with an expiring token to be sent to the entered email address, only providing episode access once the token has been correctly entered into the player).

The episode player subsystem 160 can also be implemented as a mobile application or a desktop application (e.g., that can be installed on the computing device 240) that can include an embedded version of the JavaScript library. For example, the JavaScript library can be embedded within a wrapper in the mobile application, and can provide access to the episodes 230 based on permissions associated with the user (e.g., based on links to the episode generation system 100 that have been accessed by the user, based on a user profile associated with the user, etc.). In such implementations, the episode player subsystem 160 can interface with intelligence systems on the computing device 240 (e.g., voice assistants, etc.) to process episode requests and provide other functionality for interfacing with the episode generation system 100.

The episode consumption analysis subsystem 170 can be configured to generate and provide data pertaining to consumption of the episodes 230 generated by the episode generation system 100. For example, the episode consumption analysis subsystem 170 can be configured to generate and provide viewer metrics including episode/scene starts (e.g., number or percentage of users that started playback on a given episode or scene), episode/scene completion (e.g., number or percentage of users that completed playback on a given episode or scene), and interactivity on scenes (e.g., number or percent of users that interacted with a given episode or scene, total number of interactions per user on a given episode or scene, etc.). The episode consumption analysis subsystem 170 can work in conjunction with the other subsystems in the broader episode generation system 100 (e.g., the analytic engine subsystem 130, the episode production subsystem 140, the episode player subsystem 160, etc.) to provide this functionality. As such, the episode consumption analysis subsystem 170 can provide a feedback loop for users of the episode generation system 100 that provides insight into general content preferences, areas for episode improvement, per-viewer content preferences and interests, and other insights. Accordingly, the functionality provided by the episode consumption analysis subsystem 170 can allow for improved design of the episodes 230 for various purposes.

The episode interaction subsystem 175 can generally be configured to support multiple avenues for interactivity between users and the episodes 230. For example, the episode interaction system 175 can allow a user to provide inputs via the user interface 242 on the computing device 240 before, during, or after presentation of the episodes 230. The episode interaction subsystem 175 can support interactivity with the episodes 230 via rollovers to reveal information or widgets, via standby scenes, via on-demand scenes, via an interaction service (or an interaction API), via hover states or click actions (e.g., to expose tooltips, modals, and even full scenes), via decision trees of content based on key scenes (e.g., which section to jump to next), via the dynamic generation of additional scene options based on the context of the element interacted with (e.g., a bar chart scene depicting a metric across a set of categories might present the option to generate a new scene based on the constituent elements of a given category bar when interacting with it if the data is available to provide it), via calls to action in the context of the episode (e.g., “click here to have your advisor contact you”). The episode interaction subsystem 175 can also leverage user preferences to determine which types of interactive elements to include in the episode 230 (e.g., using “education mode” to describe key terms for certain users). Referring to the example support scene 870 as shown in FIG. 8N, the episode interaction subsystem 175 can support interactivity by allowing the user to select (e.g., via the user interface 242 on the computing device 240) different support options (access to research, visit chat forums, speak to an advisor). Responsive to receiving a user input based on the selection of one of the support options, the episode interaction subsystem 175 can perform various actions (e.g., schedule a call with an advisor, provide links to various resources, etc.).

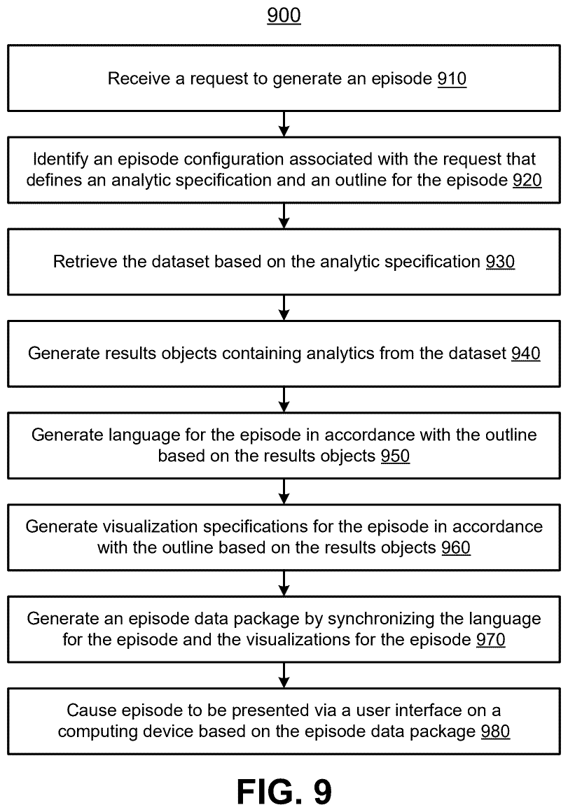

Referring to FIG. 9, a flow diagram illustrating an example episode generation process 900 that can be performed by the episode generation system 100 is shown, in accordance with some aspects of the disclosure. The process 900 can be used by the episode generation system 100 to generate the episodes 230 in a flexible and deterministic manner that allows the episode generation system 100 to provide customization (e.g., multi-sensory personalization, theming, etc.), traceability (e.g., for compliance purposes in regulated industries), allows for adaptation for use with external systems and tools (e.g., the artificial intelligence systems 220 and the models 222), and other advantages. The process 900 can be performed by the episode generation system 100 to provide any of a number of technical improvements in the technical field of automated digital content creation, as detailed throughout this disclosure.

At 910, the process 900 can include receiving a request to generate an episode that is associated with a dataset. For example, the episode generation system 100 can receive a request to generate one of the episodes 230. The request to generate the episode can be received manually (e.g., a one-off episode based on a user input), or the request to generate the episode can be received automatically (e.g., as part of an episode campaign, as part of a series, as part of a collection, based on a schedule, based on a trigger, etc.). For example, based on a schedule configured by a user (e.g., via the episode customization subsystem 150), the episode generation system 100 can generate a daily market brief episode similar to the daily market brief episode shown in FIGS. 5A-5D. As another example, based on a trigger (e.g., earnings event for a public equity coming up in 2 days, etc.), the episode generation system 100 can generate an earnings preview episode similar to the earnings preview episode shown in FIGS. 8A-8N. As detailed throughout the disclosure, the episode can generally explain the dataset in a “storytelling” fashion.

At 920, the process 900 can include identifying an episode configuration associated with the request that defines an analytic specification and an outline for the episode. For example, the episode generation system 100 can identify an episode configuration associated with the request received at 910 by comparing various parameters defined in the request received at 910 to episode configurations maintained by the episode configuration subsystem 120. The parameters defined in the request received at 910 can generally define the scope and shape of the requested episode (e.g., which brand to focus on, which portfolio to review, which public equity in a portfolio has an upcoming earnings event, etc.). Then, the episode generation system 100 can identify one or more of the slot generators 121, one or more of the slot templates 122, one or more of the scene templates 123, one or more of the sections 124, one or more of the iterators 125, one or more of the script templates 126, one or more of the episode templates 127, and/or one or more of the series 128 with the request received at 910. The analytic specification can generally define the data analytics that are needed for the episode (e.g., stock prices, portfolio composition, sales data, promotion data, insurance claims data, etc.). The outline can include, for example, one of the episode templates 127 and/or one of the script templates 126.

At 930, the process 900 can include retrieving the dataset based on the analytic specification. For example, the episode generation system 100 can use the system data 190, the data ingestion subsystem 110, and/or the domain modeling subsystem 115 to retrieve any and all data for inclusion in the episode based on the analytic specification. The dataset retrieved at 930 can be a partial dataset, or can include multiple separate datasets in some examples. The domain modeling system 115 can generally provide an interface between the episode generation system 100 and the external data 210 by using a domain graph and a mapping between the domain graph and the external data 210. The dataset retrieved at 930 can include data retrieved from one or more external databases (or other types of data sources) and/or data stored internally to the episode generation system 100 in the system data 190. The domain modeling system 115 can also apply semantics to the data retrieved at 930 to make the data queryable by other components of the episode generation system 100 and make the data understandable by the analytic engine subsystem 130.

At 940, the process 900 can include generating results objects containing analytics from the dataset. For example, the episode generation system 100 can use the analytic engine subsystem 130 can generate the results objects based on the data retrieved at 930 and in accordance with the analytic specification defined by the episode configuration. To generate the results objects, the analytic engine subsystem 130 can leverage the data wrapper 131, the story types 132, the story analytics 133, the scripting language 134, the summaries 135, the weights 136, and/or the history analyzer 137 as detailed above. The results objects can generally include data objects recognizable by the episode production subsystem 140 that include the analytics needed to generate the requested episode. For example, referring to the example exchange rate scene 520 shown in FIG. 5B, the results objects can include specific values for the EUR/USD exchange rate, the GBP/USD exchange rate, the USD/JPY exchange rate, and the USD/CHF exchange rate. As another example, referring to the example performance comparison scene 815 shown in FIG. 8C, the results objects can include specific values for the performance of Apple Inc. stock over the past year, performance of the S&P 500 over the past year, and performance of the S&P 500 Tech Index over the past year.

At 950, the process 900 can include generating language for the episode in accordance with the outline based on the results objects. For example, the episode generation system 100 can use the episode production subsystem 140, and the language generator 142 more specifically, to generate language for the requested episode in accordance with the outline based on the results objects generated at 940. To generate the language for the episode at 950, the episode production subsystem 140 can interface with a large language model (e.g., the models 222). In particular, the episode production subsystem 140 can provide one or more prompts to the large language model that constrain the large language model to a context window associated with the results objects. For example, the episode production subsystem 140 can provide dynamically generated prompts to the large language model that provide a relevant information context window based on the results objects and constrain the large language model with prompt-based direction based on states in the results objects. In this manner, the episode production subsystem 140 can help prevent the large language model from hallucinating.

Also, to provide an added layer of deterministic capabilities, the episode production subsystem 140 can fact check any and all outputs received from the large model. For example, the episode generation system 100 can compare the outputs received from the large language model responsive to the prompts to the results objects to make sure that the facts included in the outputs received from the large language model do indeed match the facts defined by the results objects. The episode production subsystem 140 can also generate language for the episode at 950 by populating a template based on the results objects. The language generation performed at 950 can also include generating voiceover (e.g., via one or more MP3 audio files, etc.) for playback as part of the episode. The language generation performed at 950 can also include generating language in one or more different languages (e.g., English, Spanish, German, etc.).

At 960, the process 900 can include generating visualization specifications for the episode in accordance with the outline based on the results objects. For example, the episode generation system 100 can use the episode production subsystem 140 to generate specifications for various types of visual elements to be included in the episode. The visual elements can include bar graphs (e.g., as shown in the example performance comparison scene 815 in FIG. 8C), line charts (e.g., as shown in the example growth trend scene 730 in FIG. 7C), data tables (e.g., as shown in the example commodity performance scene 510 in FIG. 5A), interactive elements (e.g., as shown in the example action scene 840 in FIG. 8H), and other types of visual elements. The generated visualization specifications at 960 can also include theme elements (e.g., colors, fonts, layouts, backgrounds, etc. as configured via the episode customization subsystem 150) and any embedded media elements (e.g., avatars, videos, images, etc.).

At 970, the process 900 can include generating an episode data package by synchronizing the language for the episode and the visualizations for the episode. For example, the episode production subsystem 140 can synchronize the language for the episode generated at 950 and the visualizations for the episode generated at 960 by applying tags (e.g., timestamps, etc.) to the appropriate narration scripts, voiceover files, and visualization specifications, and synchronizing the tags within the episode data package in a format such that the episode player subsystem 160 can use the episode data package to appropriately play back the requested episode. The episode data package can include, for example, one or more audio files (e.g., MP3 files) and one or more text files (e.g., JSON files) containing all relevant scene data and metadata, layout settings, scripts event markers, and any other elements for playing the episode (e.g., transitions, lengths, etc.). As detailed above, the episode production subsystem 140 can also generate various other types of assets as addendums to the episode. The episode production subsystem 140 can also generate and produce a diagnostic script that details how the episode data package was generated to facilitate compliance and traceability functions. For example, the diagnostic script can include metadata about how the episode data package was generated.

At 980, the process 900 can include causing the episode to be presented via a user interface on a computing device based on the episode data package. For example, the episode player subsystem 160 can cause the episode to be presented via the user interface 242 on the computing device 240 based on the episode data package generated at 970. As detailed above, the episode player subsystem 160 can be a library (e.g., a JavaScript library, etc.) that interprets one or more text files (e.g., JSON files, etc.), one or more audio files (e.g., MP3 files, etc.) and/or any other data associated with the episode data package to cause the episode to be presented via the user interface on the computing device. The episode player subsystem 160 can be embedded on a website or other type of web application, for example. The episode player subsystem 160 can also be provided via a mobile application or provided a desktop application, among other possible implementations.

It should be noted that while the steps of the process 900 are shown in a particular order in FIG. 9, the process 900 may not include all steps shown, may include additional steps, or may include the steps in a different order. For example, some episode generation runs performed by the episode generation system 100 may not include various components of the generation pipeline depending on multiple factors (e.g., whether the data available is insufficient for a full generation, if elements of pre-generated content are sent with a generation request, etc.). As such, in some examples, the episode generation system 100 can omit various functions performed by the analytic engine subsystem 130 or the episode production subsystem 140. The episode generation system 100 can also perform “preflight checks” and generate short videos (e.g., one scene videos) that explain some kind of error to the user. For example, if the episode generation system 100 receives a request to generate an account review episode, but the account associated with the request to generate the account review episode has incomplete or missing data, the episode generation system 100 can generate a short video with a scene that explains the deficiency in the data (e.g., “the system attempted to generate an account review episode for you, but it appears you have no data associated with your account . . . if you have any questions about this, please reach out to your account manager”).

Accordingly, as detailed above, the episode generation system 100 can support distribution and access to data-driven, insight-rich, interactive information across domains in highly consumable and memorable forms without the requirement that the viewer be knowledgeable about data analysis or database systems. The episode generation system 100 can perform data ingestion, analysis, narration, visualization and animation generation, styling including voiceover and music style, delivery, consumption, and feedback loops in a manner that does not seek to replace the two different generative paradigms with a third, but instead leverages components of each where useful and applicable alongside a variety of additional components and all in pursuit of a more sophisticated collective output. The episodes 230 thus may not be limited to just a paragraph, an image, or a one-off video snippet, but instead can be full episodes of traceable, auditable information that the user experiences like an interactive video-a series of scenes with a coherent thread across them organized in and browseable by sections, each one presenting facts and information in both audio and visual or, in certain consumption contexts as necessary, flexibly in audio or visual with animation, transitions, narration, visual cues to draw attention at key moments in the voiceover, background music, and themes both visual-colors, images, fonts—and auditory—background music, voiceover style.

The episode generation system 100 can generate the episodes 230 on demand or on a schedule autonomously by runtime from configuration elements, settings, and a database with no human involvement on any individual episode, such that highly personalized episodes can be rendered and delivered at scale to a wide range of viewers. The underlying generative runtime of the episode generation system 100 can leverage a variety of supporting techniques in pursuit of this output, including, but not limited to, domain modeling, data mapping from semantic graphs back to underlying databases, semantics-driven query generation, parameterized compositional analytics, language generation and variability, voiceover generation, music and imagery selection, audio-visual sync through topic tagging in language and mapping relevant sequences in the generated audio to visual events, and interactive functionality for interrogating the information context behind each scene and to potentially prod the generation of new information contexts and scenes.

The episode generation system 100 can include a specialized player library (e.g., the episode player subsystem 160) that can render the output of the generative pipeline for viewer playback, as described herein. This ensemble of techniques can form a vertical integration from data ingestion through content delivery, organized as a series of components that can be adapted to new domains and datasets with unique configuration elements defined via an associated configuration editor user interface to drive generation attendant to the delivery target. A related aspect of the episode generation system 100 is that the result of this generative pipeline may not be a rendered video in the traditional sense, but instead can be a data structure representing all components of the script to be played back, with its primary content subcomponent being a list of scenes or information contexts, each rendered in a hierarchy of focus, facts, follow-ons, checks, assessments, and insights, and each converted into a user-focused deliverable with visualization settings and data, narration files, and various animation cues during the back half of the generative pipeline.

The player component of the episode generation system 100 (e.g., the episode player subsystem 160) can then ingest this representation to render a video-like experience composed of motion graphics, visualizations, animation, narration, and other embedded media including images, audio and traditional video, and incorporating all elements of the associated theming and personalization as dictated by the script. The player's user-facing design (e.g., the user interface 242) can be informed by typical web video experiences-playbar to track progress, standard video playback control such as play, pause and mute, and navigation to different sections and scene. However, the episode generation system 100 can also enable unique forms of interactivity from tooltips to follow-up interactions that generate new scenes on demand, the ability to track deep engagement metrics, and support for annotation collaboration tools such as two viewers of the same episode being able to engage in discussion via a comment thread associated not with the overall video, but instead a particular visualization element or metric on a specific scene, or an advisor adding, or an advisor adding commentary to a pre-generated episode before sending it to a client (e.g., via the episode interaction subsystem 175).

The episode generation system 100 can combine a dynamic, domain-agnostic analytics pipeline with a generative pipeline aimed at the creation and delivery of interactive data-driven video at scale and without human involvement in the curation or delivery of any individual episode. Further, the episode generation system 100 can dynamically generate rich, fact-based information contexts that back individual scenes, and can also be used in some incarnations to create contexts (e.g., “context windows”) and generate prompts for large language model based narration script generation (with accompanying post hoc fact checking by extracting facts from resulting language and comparing them to inputs) and/or conversational experiences. In order to support the episode generation system 100, a series of configuration elements can be included (e.g., via the episode configuration subsystem 120). A subset of this configuration can include a hierarchy of script components unique in their collective definition of a “generative episode object”—from the bottom up: analytic specifications; scene (slot) generator specifications (e.g., collections of analytics with a shared purpose that create semantic information contexts that can have associated information prioritization), visualization templates, and language forms; scene specifications, which can be parameterized generators; and script specifications, which can be a collection of scenes organized in sections, each with their own parameters and ontological contexts, and a host of additional metadata (e.g. theme elements, background images, and voiceover settings). To parameterize those scene and script specifications, configuration specifying domain elements in constrained semantic graphs with entities, attributes, relationships and language elements, as well as data mappings inclusive of data filters, transforms, and alternative analytic plans that support the ability to leverage pre-aggregated data without losing semantic representation can be used.

At runtime, the episode generation system 100 can then leverage that configuration to configure 1) a “Data Wrapper” component, compiled to a specific combination of a domain and a database, for the dynamic formulation of analytic queries (e.g., as invoked by scene generators and through chaining of requirements) against databases (e.g., SQL databases), including capabilities necessary to leverage multiple databases within the scope of one information context and to take into account previous script objects in an episodic series for mining previously conveyed content (e.g., for references, for summaries, for tailoring future content, etc.); 2) “slot generators” serving as information context generators that can be invoked by simple configurations and parameterized by domain ontology components, each mapping to scene types (e.g., leaderboard, track benchmark, explore group, etc.) and each creating rich information contexts in a focus, facts, follow-ons, checks, assessments, and insights hierarchy; 3) deeply customizable language components with reasonable defaults that can leverage those scoped contexts and can also leverage viewer information such as skill level, user history, and event circumstance; 4) a personalization step that can leverage both theme configurations and any available viewer data, and can optimize towards “multi-sensory personalization” (e.g., narrator style, images, colors, layout settings, background music, etc.); and 5) a narrator that can generate the voiceover file with an associated orchestration step to create the representation for audio-visual synchronization.

Further, the pattern of generating rich, hierarchal (“focus, facts, follow-ons, checks, assessments, and insights”), user-aware and domain-informed information contexts from simple, well-defined configurations and inputs additionally can allow the episode generation system 100 to provide support for a) alternative types of experiences (e.g. “podcast”), b) alternative request and delivery mechanisms such as dynamic generation of episodes via chat-based requests, and c) the use of large language models as an interface to support dynamic, fact-bound conversational experiences in which a user's initial utterance (e.g., “I want to know how my brand did this past month across our top categories”) can invoke the generation of information contexts “on demand” with dozens of traceable facts derived by the episode generation system 100 (e.g., top categories for the brand, total sales of the brand last month overall and in the top categories, absolute and percentage comparisons to total sales the prior month and the same month last year overall and in top categories, other key competitors in the top category, absolute and percentage comparison to best brand in the category, worst brand in the category, average brand, and new brands, percent increase in sales over time, correlation between total sales and promotional strategies for products, etc.). This information can then become a context window filler for subsequent question-answering against factual information.

Various aspects of the episode generation system 100 are unique for a number of reasons, including, but not limited to, a) the autonomous creation and presentation of interactive video-like experiences with support for alternative modalities of information delivery (including podcast, PDF, and “storyboard” layout); b) the configuration elements that define the scope, content and presentation elements of each generated “episode” or “series” in a way that can be mapped to new domains and datasets without changes to the core architecture; c) the assembly of runtime components and libraries that take parameterized requests and execute upon that configuration and against database(s) to autonomously generate the video representation, inclusive of composable database queries and analytics, information organization in a focus, facts, follow-ons, checks, assessments, and insights hierarchy across discrete-but-related information contexts as scenes, the sharing of information across scenes for context and parameterization, language generation (e.g., through a composable hierarchy of templates invoking elements from the domain graph and the output of analytics, or via a large language model for which earlier steps compose a context window and prompt for the generation of narration and subsequent fact checking), voiceover file generation flexibly leveraging third-party models, theme selection, visualization rendering and animation, orchestration to sync audio and visual elements, and delivery of a “script” object; d) the episode player component that can receive the script object and provide a video-like experience in a JavaScript-based environment, supporting rich interactivity in addition to video-like playback and alternative presentation modalities (e.g., “storyboard”); c) the dynamic theming elements that can be tailored and influenced by a number of factors, from preconfigured themes settings right down to demographics of a particular viewer or outcomes in the data; f) the mechanisms to support dynamic exploration by using point/click to invoke the exposure of new information on demand and/or leveraging large language models for controlled conversational experiences against system-generated information contexts; g) the mechanisms such experiences support around access, security, and viewer engagement analytics including heat map of engagement with player chrome (e.g., playbar) and in-scene information elements traceable down to the individual metric or data point via tracking rollovers, clicks and other engagement, as well as follow up questions; h) the leveraging of viewer engagement data to better tailor future episodes to individual users based on their playback selections and follow-up interactions, i) the annotation and collaboration mechanics supported by the snapshot-in-time nature of these outputs as discrete, snapshot-in-time documents, with the granularity of information contexts reflected across scenes and even across the discrete visual elements within each scene (e.g., the dots on a line chart) that, when coupled with the player library, can create anchors for interaction and collaboration, and j) the user can experience a configuration-driven system as described can support, including the ability to configure one off “experimental” episodes from scratch as well as script templates and episode templates for scaled generation and delivery based on parameters and/or datasets.

Additionally, the configuration experience associated with episode generation system 100 can provide a variety of unique aspects. For example, large language models can be leveraged to capture domain or script template specific user intent in configuring aspects of the episode generation system 100 and updating the episode generation system 100 composable language templates for fluency and variability for deterministic downstream episode generation. Accordingly, the episode generation system 100 can introduce a unique dynamic where language models can generate not downstream viewer-facing content, but can instead operate on an interstitial representation of compositional configuration elements for configurer review and approval and subsequent use in language rendering and variability.

The episode generation system 100 can not only support dynamic content, but can also supports multisensory personalization, which can include dynamic theming of multiple modalities of the episode presentation, including changes to narrator voice, background music, colors, fonts, background images and other “brochureware” (e.g., the inclusion of MP4 video for playback within a scene). This theming capability provided by the episode generation system 100 can be set at an organization-level across episodes, at a series-level, or at a scene-level, and can further be dynamically adjusted during the generation of a single episode based on states in the data or information about the viewer the episode is intended for. For example, if a portfolio update episode is being sent to a mid-career professional in their 40 s versus a retired senior in their 70 s, much of the content can be reactive to not only the portfolio, but also the goals and targets. Beyond that, however, the theme might also change. For example, the narrator's voice, background music, and imagery for the episode can be tailored to the viewer. Further, the voiceover tone, color choices and imagery can be adjusted based on outcomes being perceived as positive or negative.

Also, because the episode generation system 100 can produce the episodes 230 as documents representing snapshots in time, and because the delivery mechanisms can serve visuals as discrete, semantically tagged Document Object Model (DOM) elements that can have events attached, the episode generation system 100 can support human-to-human collaboration on top of the elements of the episodes 230 in addition to other types of interactivity, as noted. The viewer could also tag a fellow member of their team, their portfolio advisor, or their insurance broker directly on an element during playback and ask an in-context question that could be made either a) private between only the viewer and intended recipient, or b) public such that anyone with access to the video could also see the comment (e.g., when someone might want to add context to a particular figure in a monthly episode for a broader team). Additionally, the portfolio advisor might add comments and annotation to an episode before it is sent out to that viewer.

Given the variety of interactions that can be supported by the episode generation system 100, and the deeper semantic representation of the types of information viewers can experience through it, the episode generation system 100 can collect a hybrid of engagement data that goes further than traditional web or video analytics. The episode generation system 100 (e.g., via the episode consumption analysis system 170) can track a variety of data including playback, which scenes were watched, whether the full video was watched, discrete topical areas of interest at the level of metrics, and types of outcomes associated with those metrics. As a result, the episode generation system 100 can answer questions such as when the portfolio is down, what follow ups does a particular viewer request of the system, what additional information do they care about, what questions do they leave for their advisor, and on what data points. The episode generation system 100 can determine what this looks like across groups of viewers and whether there are patterns, and can also determine whether specific individuals have unique, specific concerns when certain events occur in the underlying data.

The episode generation system 100 can also provide rollups of this type of engagement to improve understanding of viewer behavior. For example, the episode generation system 100 can track viewer interest not at the level of scenes, but at the level of metrics and outcomes, and can also use this data as fodder to improve the episodes 230 (e.g., to highlight a particular bit of information in certain contexts and/or for certain viewers, or to proactively suggest to episode presenters, such as the portfolio advisor, that particular episodes are likely to trigger certain types of engagement from certain viewers). For example, a feedback loop with this information can be built directly into the episode generation system 100 so that individual videos can be further tailored to unique viewers based on previous engagement data.

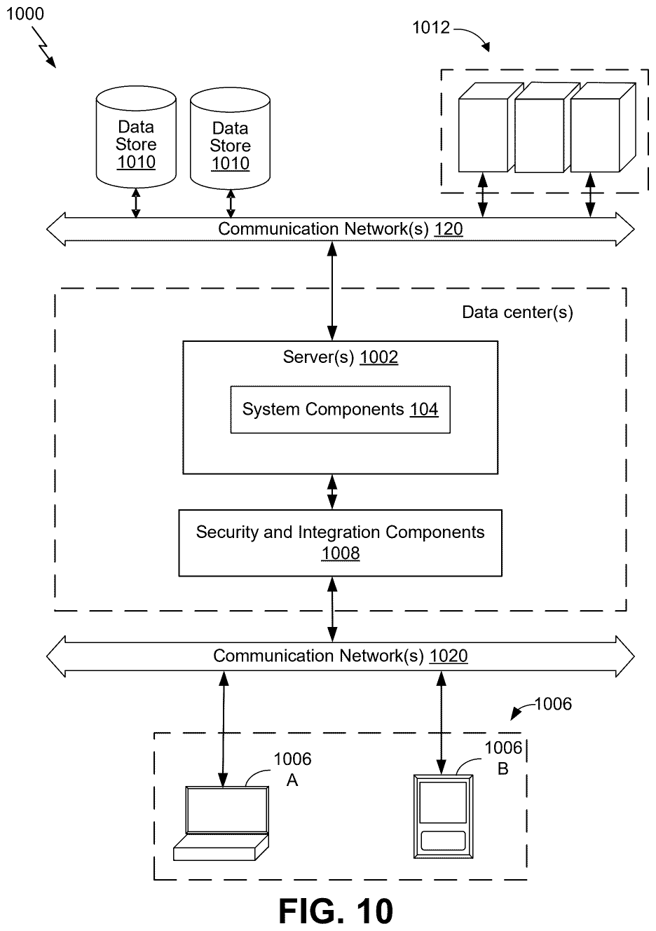

Referring to FIG. 10, a non-limiting example of a distributed computing environment 1000 is shown, in accordance with some aspects of the disclosure. In some examples, the distributed computing environment 1000 may include one or more server(s) 1002 (e.g., data servers, computing devices, computers, etc.), one or more client computing devices 1006, and/or other components that may implement certain features described herein. Other devices, such as specialized sensor devices, etc., may interact with the client computing device(s) 1006 and/or the server(s) 1002. The server(s) 1002, client computing device(s) 1006, or any other devices may be configured to implement a client-server model or any other distributed computing architecture. In an illustrative and non-limiting example, the client devices 1006 may include a first client device 1006A and a second client device 1006B. The first client device 1006A may correspond to a first user of the episode generation system 100 and the second client device 1006B may correspond to a second user of the episode generation system 100. In some examples, the client devices 1006 can include a virtual reality headset or any other suitable computing device with a display (e.g., smartphone, tablet, laptop computer, etc.).

In some examples, the server(s) 1002, the client computing device(s) 1006, and any other disclosed devices may be communicatively coupled via one or more communication network(s) 1020. The communication network(s) 1020 may be any type of communication networks supporting data communications. As non-limiting examples, network 1020 may be a local area network (LAN; e.g., Ethernet, Token-Ring, etc.), a wide-area network (e.g., the Internet), an infrared or wireless network, a public switched telephone networks (PSTNs), a virtual network, etc. Network 1020 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

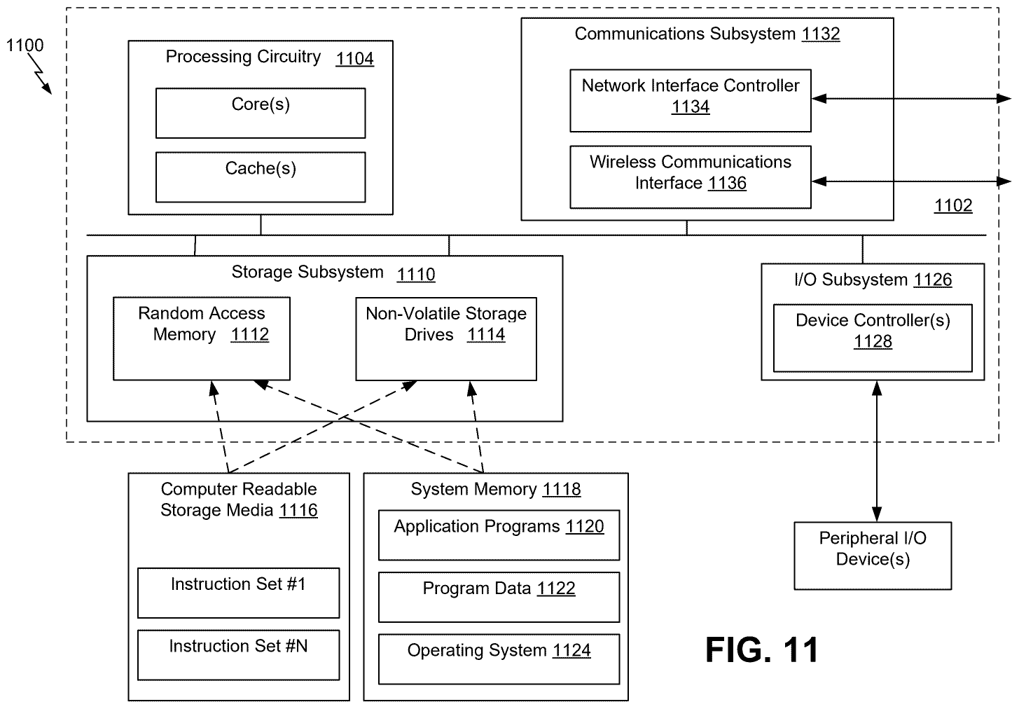

The examples shown in FIG. 10 and/or FIG. 11 are respective examples of a distributed computing system and are not intended to be limiting. The subsystems and components within the server(s) 1002 and the client computing device(s) 1006 may be implemented in hardware, firmware, software, or combinations thereof. Various different subsystems and/or components 1004 may be implemented on the server 1002. Users operating the client computing device(s) 1006 may initiate one or more client applications to use services provided by these subsystems and components. Various different system configurations are possible in different types of distributed computing environments and content distribution networks. Server 1002 may be configured to run one or more server software applications or services, for example, web-based or cloud-based services, to support content distribution and interaction with client computing device(s) 1006. Users operating client computing device(s) 1006 may in turn utilize one or more client applications (e.g., virtual client applications) to interact with server 1002 to utilize the services provided by these components. The client computing device(s) 1006 may be configured to receive and execute client applications over the communication network(s) 1020. Such client applications may be web browser-based applications and/or standalone software applications, such as mobile device applications. The client computing device(s) 1006 may receive client applications from server 1002 or from other application providers (e.g., public or private application stores).

As shown in FIG. 10, various security and integration components 1008 may be used to manage communications over the communication network(s) 1020 (e.g., a file-based integration scheme, a service-based integration scheme, etc.). In some examples, the security and integration components 1008 may implement various security features for data transmission and storage, such as authenticating users or restricting access to unknown or unauthorized users. As non-limiting examples, the security and integration components 1008 may include any dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 1008 may transmit data between the various devices in the distribution computing environment 1000 (e.g., in a content distribution system or network). In some examples, the security and integration components 1008 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 1000, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 1002 and other network components. In such examples, the security and integration components 1008 may thus provide secure web services, thereby allowing any external devices to communicate directly with the specialized hardware, network appliances, etc.

The distributed computing environment 1000 may further include one or more data stores 110. In some examples, the one or more data stores 1010 may include, and/or reside on, one or more back-end servers 1012, operating in one or more data center(s) in one or more physical locations. In such examples, the one or more data stores 1010 may communicate data between one or more devices, such as those connected via the one or more communication network(s) 1020. In some cases, the one or more data stores 1010 may reside on a non-transitory storage medium within one or more server(s) 1002. In some examples, data stores 1010 and back-end servers 1012 may reside in a storage-area network (SAN). In addition, access to one or more data stores 1010, in some examples, may be limited and/or denied based on the processes, user credentials, and/or devices attempting to interact with the one or more data stores 1010.

Referring to FIG. 11, a block diagram of an example computing system 1100 is shown, in accordance with some aspects of the disclosure. The computing system 1100 (e.g., one or more connected computers) may correspond to any one or more of the computing devices or servers of the distributed computing environment 1000, or any other computing devices described herein. In an example, the computing system 1100 may represent an example of one or more server(s) 1002 and/or of one or more server(s) 1012 of the distributed computing environment 1000. In another example, the computing system 1100 may represent an example of the client computing device(s) 1006 of the distributed computing environment 1100. In some examples, the computing system 1100 may represent a combination of one or more computing devices and/or servers of the distributed computing environment 1000. In some examples, the computing system 1100 may include processing circuitry 1104, such as one or more processing unit(s), processor(s), etc. In some examples, the processing circuitry 1104 may communicate (e.g., interface) electronically with a number of peripheral subsystems via a bus subsystem 1102. These peripheral subsystems may include, for example, a storage subsystem 1110, an input/output (I/O) subsystem 1126, and a communications subsystem 1132.

In some examples, the processing circuitry 1104 may be implemented as one or more integrated circuits (e.g., a micro-processor or microcontroller). In an example, the processing circuitry 1104 may control the operation of the computing system 1100. The processing circuitry 1104 may include single core and/or multicore (e.g., quad core, hexa-core, octo-core, ten-core, etc.) processors and processor caches (e.g., central processing units (CPUs), graphics processing units (GPUs), etc.). The processing circuitry 1104 may execute a variety of resident software processes embodied in program code, and may maintain multiple concurrently executing programs or processes. In some examples, the processing circuitry 1104 may include one or more specialized processors, (e.g., digital signal processors (DSPs), outboard, graphics application-specific, and/or other processors).

In some examples, the bus subsystem 1102 provides a mechanism for intended communication between the various components and subsystems of the computing system 1100. Although the bus subsystem 1102 is shown schematically as a single bus, other implementations of the bus subsystem may utilize multiple buses. In some examples, the bus subsystem 1102 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard, etc.).

In some examples, the I/O subsystem 1126 may include one or more device controller(s) 1128 for one or more user interface input devices and/or user interface output devices, possibly integrated with the computing system 1100 (e.g., virtual reality headsets, integrated audio/video systems, and/or touchscreen displays), or may be separate peripheral devices which are attachable/detachable from the computing system 1100. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 1100, such as to a user (e.g., via a display device) or any other computing system, such as a second computing system 1100. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, virtual reality headsets, indicator lights, monitors, printers, speakers, headphones, automotive navigation systems, plotters, voice output devices, modems, etc.

In some examples, the computing system 1100 may include one or more storage subsystems 1110, including hardware and software components used for storing data and program instructions, such as system memory 1118 and computer-readable storage media 1116. In some examples, the system memory 1118 and/or the computer-readable storage media 1116 may store and/or include program instructions that are loadable and executable on the processor(s) 1104. In an example, the system memory 1118 may load and/or execute an operating system 1124, program data 1122, server applications, application program(s) 1120 (e.g., client applications), Internet browsers, mid-tier applications, etc. In some examples, the system memory 1118 may further store data generated during execution of these instructions.

In some examples, the system memory 1118 may be stored in volatile memory (e.g., random-access memory (RAM) 1112, including static random-access memory (SRAM) or dynamic random-access memory (DRAM)). In an example, the RAM 1112 may contain data and/or program modules that are immediately accessible to and/or operated and executed by the processing circuitry 1104. In some examples, the system memory 1118 may also be stored in non-volatile storage drives 1114 (e.g., read-only memory (ROM), flash memory, etc.). In an example, a basic input/output system (BIOS), containing the basic routines that help to transfer information between elements within the computing system 1100 (e.g., during start-up), may typically be stored in the non-volatile storage drives 1114.

In some examples, the storage subsystem 1110 may include one or more tangible computer-readable storage media 1116 for storing the basic programming and data constructs that provide various functionality. In an example, the storage subsystem 1110 may include software, programs, code modules, instructions, etc., that may be executed by the processing circuitry 1104, in order to provide the functionality described herein. In some examples, data generated from the executed software, programs, code, modules, or instructions may be stored within a data storage repository within the storage subsystem 1110. In some examples, the storage subsystem 1110 may also include a computer-readable storage media reader connected to the computer-readable storage media 1116.

In some examples, the computer-readable storage media 1116 may contain program code, or portions of program code. Together and optionally in combination with the system memory 1118, the computer-readable storage media 1116 may comprehensively represent remote, local, fixed, and/or removable storage devices plus storage media for temporarily and/or more permanently containing, storing, transmitting, and/or retrieving computer-readable information. In some examples, the computer-readable storage media 1116 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information, and which can be accessed by the computing system 1100. In an illustrative and non-limiting example, the computer-readable storage media 1116 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 1116 may include, but is not limited to, Zip® drives, flash memory cards, universal serial bus (USB) flash drives, secure digital (SD) cards, DVD disks, digital video tape, and the like. In some examples, the computer-readable storage media 1116 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 1100.

In some examples, the communications subsystem 1132 may provide a communication interface from the computing system 1100 and external computing devices via one or more communication networks, including local area networks (LANs), wide area networks (WANs) (e.g., the Internet), and various wireless telecommunications networks. As illustrated in FIG. 11, the communications subsystem 1132 may include, for example, one or more network interface controllers (NICs) 1134, such as Ethernet cards, Asynchronous Transfer Mode NICs, Token Ring NICs, and the like, as well as one or more wireless communications interfaces 1136, such as wireless network interface controllers (WNICs), wireless network adapters, and the like. Additionally, and/or alternatively, the communications subsystem 1132 may include one or more modems (telephone, satellite, cable, ISDN), synchronous or asynchronous digital subscriber line (DSL) units, Fire Wire® interfaces, USB® interfaces, and the like. Communications subsystem 1132 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 1132 may also receive input communication in the form of structured and/or unstructured data feeds, event streams, event updates, and the like, on behalf of one or more users who may use or access the computing system 1100. In an example, the communications subsystem 1132 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 1132 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 1132 may output such structured and/or unstructured data feeds, event streams, event updates, and the like to one or more data stores that may be in communication with one or more streaming data source computing systems (e.g., one or more data source computers, etc.) coupled to the computing system 1100. The various physical components of the communications subsystem 1132 may be detachable components coupled to the computing system 1100 via a computer network (e.g., a communication network 1020), a Fire Wire® bus, or the like, and/or may be physically integrated onto a motherboard of the computing system11200. In some examples, the communications subsystem 1132 may be implemented in whole or in part by software.

Due to the ever-changing nature of computers and networks, the description of the computing system 1100 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various aspects of the disclosure.

1. A computing system for generating episodes, the system comprising:
a data ingestion subsystem to ingest data from external databases;
a domain modeling subsystem to apply semantics to the data and provide an interface with the external databases;
an episode configuration subsystem to define and manage episode configurations;
an analytic engine subsystem to generate results objects containing analytics from the data according to the episode configurations by leveraging the interface with the external databases;
an episode production subsystem to generate episode data packages for the episodes based on the results objects, the episode data packages comprising language for the episodes and visualization specifications for the episodes; and
an episode player subsystem to play the episodes based on the episode data packages on a computing device via a user interface.

2. The system of claim 1, further comprising an episode interaction subsystem to facilitate interactivity with the episodes based on user inputs provided on the computing device via the user interface.

3. The system of claim 1, further comprising an episode customization subsystem to enable a user to manage creation and distribution of the episodes on the computing device via the user interface.

4. The system of claim 3, wherein the episode customization subsystem is to enable the user to personalize the episodes in accordance with theming elements.

5. The system of claim 1, wherein, to generate the language for the episodes, the episode production subsystem is to interface with a large language model.

6. The system of claim 5, wherein, to interface with the large language model, the episode production subsystem is to provide prompts that constrain the large language model to a context window associated with the results objects.

7. The system of claim 6, wherein, to generate the language for the episodes, the episode production subsystem is to fact check outputs provided by the large language model by comparing the outputs provided by the large language model to the results objects.

8. The system of claim 1, wherein, to generate the language for the episodes, the episode production subsystem is to populate a template based on the results objects.

9. The system of claim 1, wherein the domain modeling subsystem is to provide the interface with the external databases using a domain graph and a mapping between the domain graph and the external databases.

10. The system of claim 1, wherein the data ingestion subsystem is to ingest unstructured data from the external databases.

11. The system of claim 1, wherein the episode production subsystem is to generate diagnostic scripts associated with the episodes, the diagnostic scripts detailing how the episode data packages are generated.

12. The system of claim 1, wherein the episode data packages comprise text files and audio files, and wherein the episode player subsystem comprises a library to interpret the text files and the audio files.

13. A computer-implemented method, comprising:
receiving a request to generate an episode that associated with a dataset;
identifying an episode configuration associated with the request to generate the episode, wherein the episode configuration defines an analytic specification for the episode and an outline for the episode;
retrieving the dataset from a database based on the analytic specification that is defined by the episode configuration by leveraging a domain graph and a mapping between the domain graph and the database;
generating results objects containing analytics from the dataset in accordance with the analytic specification;
generating language for the episode in accordance with the outline for the episode based on the results objects;
generating visualization specifications for the episode in accordance with the outline for the episode based on the results objects;
generating an episode data package for the episode by synchronizing the language for the episode and the visualization specifications for the episode; and
causing the episode to be presented via a user interface on a computing device based on the episode data package.

14. The method of claim 13, wherein generating the language for the episode based on the results objects comprises interfacing with a large language model.

15. The method of claim 14, wherein interfacing with the large language model comprises providing a prompt to the large language model that constrains the large language model to a context window associated with the results objects.

16. The method of claim 15, wherein generating the language for the episode comprises fact checking an output provided by the large language model by comparing the output of the large language model to the results objects.

17. The method of claim 13, wherein retrieving the dataset from the database comprises retrieving an unstructured dataset, and wherein the method further comprises applying semantics to the unstructured dataset by leveraging the domain model.

18. The method of claim 13, further comprising:
receiving a user input from the computing device based on an interaction between a user of the computing device and the episode that occurs via the user interface; and
performing an action based on the user input.

19. The method of claim 13, wherein receiving the request to generate the episode comprises receiving the request to generate the episode based on a user input.

20. A non-transitory computer-readable storage medium having instructions stored thereon that, when executed by processing circuitry, cause the processing circuitry to:
receive a request to generate an episode associated with a dataset;
identify an episode configuration associated with the request to generate the episode, wherein the episode configuration defines an analytic specification for the episode and an outline for the episode;
retrieve the dataset from a database based on the analytic specification that is defined by the episode configuration by leveraging a domain graph and a mapping between the domain graph and the database;
generate results objects containing analytics from the dataset in accordance with the analytic specification;
generate language for the episode in accordance with the outline for the episode based on the results objects;
generate visualization specifications for the episode in accordance with the outline for the episode based on the results objects;
generate an episode data package for the episode by synchronizing the language for the episode and the visualization specifications for the episode; and
cause the episode to be presented via a user interface on a computing device based on the episode data package.
